(19) United States
(12) Patent Application Publication
(10) Pub. No.: US 2007/0011204 A1
(43) Pub. Date: Jan. 11, 2007

(54) Management of rights related to ideas for prospectively patentable inventions

(76) Inventors: Jens Erik Sorensen, Rancho Santa Fe, CA (US); Jens Ole Sorensen, Cayman Kai (KY)

Correspondence Address: KNOBBE MARTENS OLSON & BEAR LLP, 2040 MAIN STREET, FOURTEENTH FLOOR, IRVINE, CA, 92614, US

(21) Appl. No.: 11/519,482

(22) Filed: Sep. 11, 2006

Related U.S. Application Data
(63) Continuation of application No. 09/980,654, filed on Oct. 25, 2001.

(51) Int. Cl. G06F 17/00

(52) U.S. Cl. 707/104.1

(57) ABSTRACT

Various methods of managing ideas include different combinations of the following acts: (a) maintaining a computer database for accumulating ideas for prospectively patentable inventions, where the ideas include needs and requirements of the inventions; (b) establishing contractual obligations by contributors of the ideas to the database to transfer property rights to inventions derived at least in part from the accumulated ideas, where the transfer is for contingent economic gain; (c) providing contingent contractual rights to at least some inventions derived at least in part from the accumulated ideas; (d) enabling receipt of contributions of the ideas for prospective entry into the database; (e) establishing contractual obligations by contributors of the ideas to the database to transfer property rights to inventions derived at least in part from the accumulated ideas to transferees other than contributors of ideas from which the invention was at least in part derived.

### RELATED APPLICATIONS

The present application is a continuation of U.S. patent application Ser. No. 09/980,654, filed Oct. 25, 2001, which is a national phase application under 35 U.S.C. § 371 of WO 02/15052, filed as PCT/US01/25317 on Aug. 10, 2001. This application claims the benefit of the filing date of U.S. Provisional Patent Application No. 60/224,944, filed Aug. 11, 2000 and of U.S. Provisional Patent Application No. 60/227,687, filed Aug. 24, 2000. These applications are hereby expressly incorporated by reference in their entireties.

### BACKGROUND AND SUMMARY OF CERTAIN INVENTIVE EMBODIMENTS

Embodiments of the present invention pertain to management of rights related to ideas for prospectively patentable inventions, wherein the ideas are accumulated in a computer database. The accumulated ideas may include needs, problems, solutions, requirements, discoveries and/or inventions. A discovery of a problem, need or requirement calling for a solution is commonly an integral idea-component of an invention.

In one embodiment, there is a method of managing rights related to ideas for prospectively patentable inventions, comprising (a) receiving ideas for prospectively patentable inventions by on-line communications from contributors of said ideas, wherein said contributed ideas include problems or needs to be solved by inventions; (b) accumulating said received ideas in a computer database; (c) utilizing a computer system to effect transfers of property rights to inventions derived at least in part from said accumulated ideas that include said problems or needs respectively contributed by said contributors, wherein said transfers are to transferees other than said contributors whom respectively contributed said problems or needs; (d) selling at least some right under the patent rights to at least some of said derived inventions; and (e) providing economic gain of stock, bonds, cash or rights to a portion of anticipated income derived from said property rights to said contributors of said problems or needs.

In another embodiment, there is a method of managing rights related to ideas for prospectively patentable inventions, comprising (a) receiving ideas for prospectively patentable inventions by on-line communications from contributors of said ideas, wherein said contributed ideas include problems or needs to be solved by inventions; (b) accumulating said received ideas in a computer database; (c) utilizing a computer system to effect transfers of property rights to inventions derived at least in part from said accumulated ideas that include said problems or needs respectively contributed by said contributors, wherein said transfers are to transferees other than said contributors whom respectively contributed said problems or needs; (d) recording a time of publication in said database of each accumulated idea; and (e) providing economic gain of stock, bonds, cash or rights to a portion of anticipated income derived from said property rights to said contributors of said problems or needs.

In another embodiment, there is a method of managing rights related to ideas for prospectively patentable inventions, comprising (a) receiving ideas for prospectively patentable inventions by on-line communications from contributors of said ideas, wherein said contributed ideas include problems or needs to be solved by inventions; (b) accumulating said received ideas in a computer database; (c) utilizing a computer system to establish obligations by said contributors of problems or needs to transfer property rights to inventions derived at least in part from said accumulated ideas that include said problems or needs contributed by said contributors, wherein said transfers are to transferees other than said contributors whom respectively contribute said problems or needs, and wherein said obligations are established as a prerequisite to contributing problems or needs; and (d) providing economic gain of stock, bonds, cash or rights to a portion of anticipated income derived from said property rights to said contributors of said problems or needs.

In another embodiment, there is a method of managing rights related to an idea for a prospectively patentable invention, comprising (a) receiving an idea for a prospectively patentable invention by an on-line communication from a contributor of said idea, wherein said contributed idea is a problem and/or a need to be solved by one or more inventions; (b) accumulating said received idea in a computer database; (c) utilizing a computer system to effect a transfer of property rights to inventions derived at least in part from said accumulated ideas that include said problem or need contributed by said contributor, wherein said transfer is to a transferee other than said contributor; (d) selling at least some right under the patent rights to at least some of said derived inventions; and (e) providing economic gain of stock, bonds, cash or rights to a portion of anticipated income derived from said property rights to said contributor of said problem and/or need.

In another embodiment, there is a computer readable storage medium(media), comprising computer executable instructions for causing a computer(s) to manage rights related to ideas for prospectively patentable inventions, wherein the instructions cause the computer(s) to perform the acts of (a) receiving ideas for prospectively patentable inventions by on-line communications from contributors of said ideas, wherein said contributed ideas include problems or needs to be solved by inventions; (b) accumulating said received ideas in a computer database; (c) effecting transfers of property rights to inventions derived at least in part from said accumulated ideas that include said problems or needs respectively contributed by said contributors, wherein said transfers are to transferees other than said contributors whom respectively contributed said problems or needs; (d) selling at least some right under the patent rights to at least some of said derived inventions; and (e) providing economic gain of stock, bonds, cash or rights to a portion of anticipated income derived from said property rights to said contributors of said problems or needs.

In yet another embodiment, there is a computer readable storage medium(media), comprising computer executable instructions for causing a computer(s) to manage rights related to ideas for prospectively patentable inventions, wherein the instructions cause the computer(s) to perform the acts of (a) receiving ideas for prospectively patentable inventions by on-line communications from contributors of said ideas, wherein said contributed ideas include problems or needs to be solved by inventions; (b) accumulating said received ideas in a computer database; (c) establishing obligations by said contributors of problems or needs to transfer property rights to inventions derived at least in part from said accumulated ideas that include said problems or needs contributed by said contributors, wherein said transfers are to transferees other than said contributors whom respectively contribute said problems or needs, and wherein said obligations are established as a prerequisite to contributing problems or needs; and (d) providing economic gain of stock, bonds, cash or rights to a portion of anticipated income derived from said property rights to said contributors of said problems or needs.

Additional features are described with reference to the detailed description of the preferred embodiments.

### BRIEF DESCRIPTION OF THE DRAWINGS

FIG. 1 is a diagram illustrating various aspects of the present invention.

FIG. 2 is a diagram of an exemplary embodiment of the organization of an integrated idea in a computer database, wherein problem ideas are indicated by squares and solution ideas are indicated by circles.

FIGS. 3 through 54 are views of various screen displays provided from a website to a user upon accessing an idea database in accordance with the present invention, wherein FIGS. 19 through 42 are related to browsing the exemplary embodiment of the integrated idea that is organized as shown FIG. 2. Views of screen displays overlapping two sheets of drawing are identified by a common FIG. number and A and B suffixes

### DETAILED DESCRIPTION

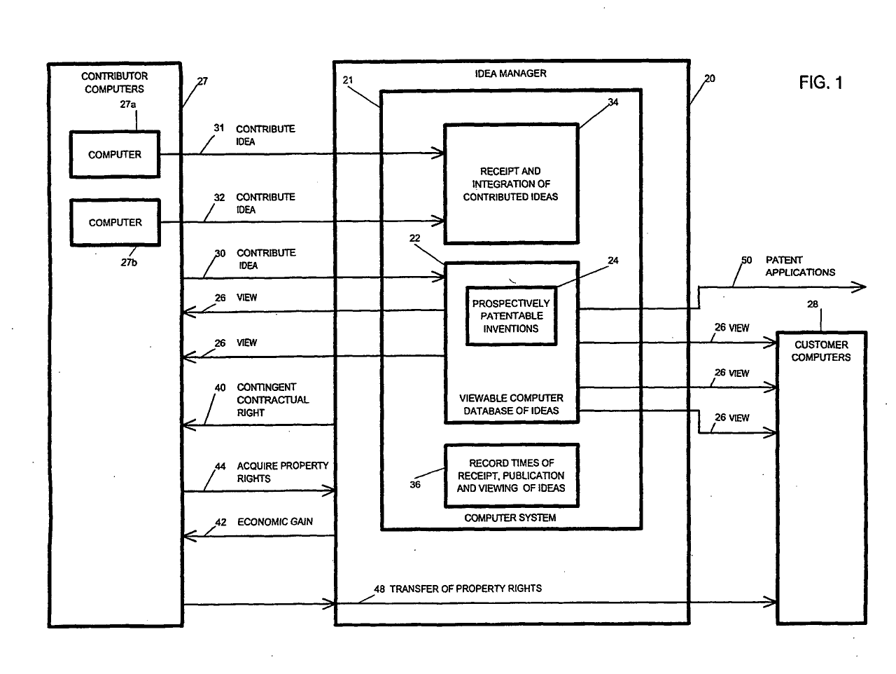

Referring to FIG. 1, in a preferred embodiment of the present invention, an idea manager 20 maintains a computer system 21 and a computer database 22 for accumulating ideas for prospectively patentable inventions. The accumulated ideas include needs and requirements of such inventions. The idea manager 20 is the proprietor of the computer database 22. The computer system 21 is adapted by hardware, firmware and/or software for performing and/or enabling performance of the various methods described herein.

The computer system 21 may include one or more computers and one or more memories contained within or coupled to the computer(s). The idea manager 20 may be one party or different parties operating in concert with one another. Idea contributors use computers 27 to view 26 the accumulated ideas in the database 22. One idea contributor can be the idea manager 20, including its staff and/or its computer system 21. Some contributor computers 27 may be shared by a plurality of contributors. Potential customers for property rights, including patent rights, to prospectively patentable inventions 24 derived at least in part from the ideas accumulated in the database 22 use computers 28 to view 26 the accumulated ideas in the database 22. In some embodiments, the contributor computers 27 may be the same as the customer computers 28 and/or the computers of the computer system 21.

The computer system 21 is programmed by the idea manager 20 to facilitate use of the contributor computers 27 to make on-line contributions of ideas 30, 31, 32 to the computer database of ideas 22. Computer programs that enable the contributor computers 27 to be used to make on-line contributions of ideas to the database 22 can be downloaded by the contributor computers 27 from the computer system 21. An on-line contribution is a contribution that is made over a communication network, such as the Internet.

In some preferred embodiments, the computer system 21 is programmed to require persons to enter into a membership as a prerequisite for viewing a portion of the database 22 containing at least some of the accumulated ideas, and to facilitate entry into such membership by on-line communications between the computer system 21 and the contributor computers 27. Entry into such a membership can also be effected by other means, such as by mail. Upon entering into a viewer membership, a person agrees to give up some legal rights. In alternative embodiments, no such membership is required for on-line viewing of any portion of the database 22 by the general public.

In some preferred embodiments, the computer system 21 is programmed to require contributors of ideas for prospective entry into the database 22 to enter into a membership as a prerequisite for contributing ideas for entry into the database 22, and to facilitate entry into such membership by on-line communications between the computer system 21 and the contributor computers 27. Entry into such a membership can also be effected by other means, such as by mail. Upon entering into a contributor membership, a person agrees to give up some legal rights and/or to transfer some property rights with respect to ideas contributed by such person. In some of the embodiments with such a membership requirement, the membership is limited to any entity that agrees to transfer or otherwise encumber property rights, including patent rights, to any inventions derived from any idea contributed by the entity. In alternative embodiments, no such membership is required for contributing ideas for entry into the database 22.

In some preferred embodiments, the computer system 21 is programmed to systematically establish contractual obligations by contributors of the ideas to the database to transfer property rights, including patent rights 48, to inventions derived at least in part from the ideas accumulated in the database 22, and to facilitate establishment of such obligations by on-line communications between the computer system 21 and the contributor computers 27. In some of these embodiments, the transfer is for contingent economic gain 42, such as for example: contingent contractual rights or shares of a portfolio of such contractual rights, or stock in the database proprietor or a party in concert with the database proprietor. In some of these embodiments, the transfer is for actual economic gain 42, such as for example: cash or bonds. In some of these embodiments, the transfer of property rights 44, 48 is to transferees other than contributors of ideas from which the invention was at least in part derived. In some of these embodiments, the transfer of property rights 44 is to a proprietor of the database 21, such as the idea manager 20, or to a party in concert with such proprietor. In some of these embodiments, the transferees are not identified upon establishing such obligations; and in some of these embodiments, the transferees are identified upon establishing such obligations.

In some preferred embodiments, the computer system 21 is programmed to systematically provide the contributors with contingent contractual rights 40 to at least some inventions derived at least in part from the ideas accumulated in the database 22, and to facilitate provision of such contingent rights by on-line communications between the computer system 21 and the contributor computers 27. The idea manager 20 systematically provides contingent contractual rights 40 to at least some of the contributors of ideas to the database 22 as an incentive for all or selected contributors to contribute ideas to the database 22; and/or compensates by economic gain 42 at least some contributor-owners of the contingent contractual rights in exchange for either acquiring 44 or facilitating transfer 48 of at least some of the property rights. The contingent contractual rights include rights to a portion of anticipated income derived from property rights under the patent rights to prospectively patentable inventions 24 derived at least in part from the ideas contributed by the contributors whom receive such contingent contractual rights 40.

The computer system 21 is programmed to enable receipt of contributions of ideas for prospective entry into the database 22, and to facilitate receipt of such contributions on-line from the contributor computers 27. In some preferred embodiments, the computer system 21 is programmed to systematically enter into the database 22 all the ideas contributed for entry into the database 22 without requiring any contributor of such ideas to have subject matter expertise as a prerequisite for entry of such contributions. In other preferred embodiments, the computer system 21 is programmed to require contributors of ideas to the database 22 to have subject matter expertise as a prerequisite for contributing ideas for prospective entry into the database 22, and facilitate entry of evidence of such expertise by on-line communications between the computer system 21 and the contributor computers 27. Such evidence can also be effected by other means, such as by mail. In still other preferred embodiments, the computer system 21 is programmed to selectively enter only some of the contributed ideas into the database 22. In some embodiments, selective entry is accomplished by systematic computer screening for relevant subject matter. In some embodiments, selective entry is accomplished by systematic computer screening for keywords and by a computer operator making a selective entry decision based upon the context in which the keywords are used.

In some preferred embodiments, the computer system 21 is programmed to systematically establish contractual obligations by the idea contributors to permit immediate public disclosure of the ideas contributed by the idea contributors, and to facilitate establishment of such obligations by on-line communications between the computer system 21 and the contributor computers 27. Preferably such permission is for immediate public disclosure of all of the ideas contributed by the contributor undertaking such contractual obligation. In some of these embodiments, the ideas received from such contributors are immediately disclosed to the public upon receipt by entry into a publicly viewable portion of the database 22 and thereby published. In other such embodiments, the disclosure is not effected or not effected immediately notwithstanding having permission to do so.

In some preferred embodiments, the computer system 21 is programmed to record (a) the time of receipt of each idea contributed for entry into the database 22; (b) the time of publication in the database 22 of each accumulated idea; (c) the time of first viewing of each idea contributed to the database; and/or (d) the time of first public viewing from the database 22 of each accumulated idea, as indicated at 36 in FIG. 1.

The computer system 21 is programmed to enable ideas contributed by one or different contributors to the database 22 to be integrated within the database 22 to thereby facilitate derivation of inventions 24 from the integrated ideas, as indicated at 34 in FIG. 1. For example, a first idea 31 contributed by a first member using the computer 27a is integrated with a second idea 32 contributed by a second member using the computer 27b to provide an integrated idea of a prospectively patentable invention 24. In another example, ideas contributed from the same computer by one or different contributors are integrated within the database 22.

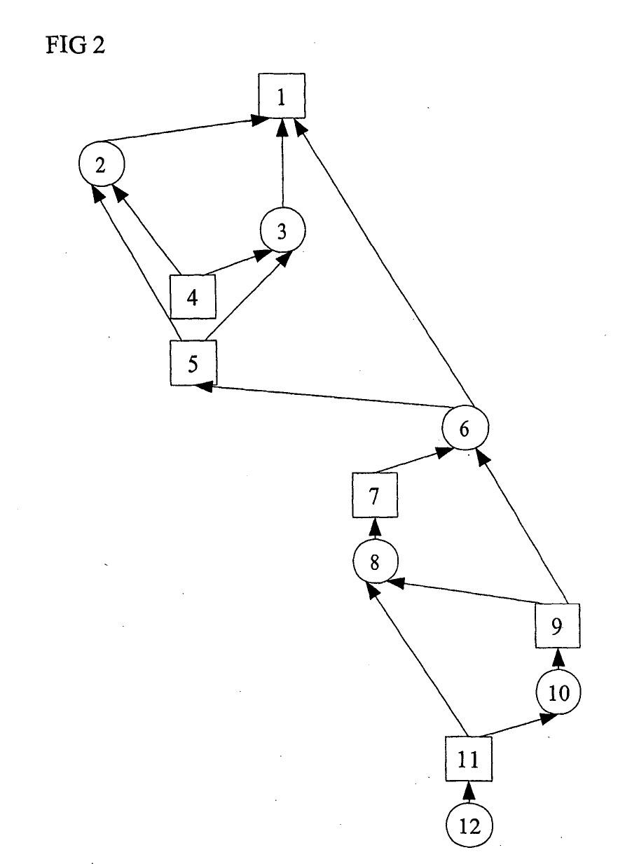

In the preferred embodiment, the related ideas that are processed to provide an integrated idea include problems and solutions. Preferably, an integrated idea is organized in the database as shown in FIG. 2 by providing access links between a problem idea (square) and one or more solution ideas (circle), and access links between a solution idea and one or more problem ideas, but generally not between a plurality of problem ideas or between a plurality of solution ideas. In this exemplary embodiment, three solution ideas 2, 3, 6 have been contributed in response to contribution of an initial problem idea 1; two problem ideas 4, 5 have been contributed in response to contribution of both of the solution ideas 2, 3, a solution idea 6 has been contributed in response to both of the problem ideas 1, 5; two problem ideas 7, 9 have been contributed in response to contribution of the solution idea 6; a solution idea 8 has been contributed in response to the problem idea 7; a problem idea 9 has been contributed in response to both of the solution ideas 6, 8; a solution idea 10 has been contributed in response to the problem idea 9; a problem idea 11 has been contributed in response to both of the solution ideas 8, 10; and a solution idea 12 has been contributed in response to the problem idea 11.

The idea contributions shown in FIG. 2 are described below in chronological order.

Problem Idea 1: Breaking Spectacles

Spectacle frames often break so that a lens will not adhere to the frame and the frame may twist out of shape and not tack on to the head. The spectacle user often is dependent on only one set of spectacles and it may take a week before they can have new frame or spectacles or have the old frame fixed. Is there a simple way for an ordinary person to temporarily fix her glasses?

Solution Idea 2: Use Glue

Glue the frame together with super glue.

Solution Idea 3. Use Glue

Glue the frame to the glass and buy new spectacles.

Problem Idea 4: Glue Doesn't Work

I have tried gluing with all kinds of glue but nothing has worked.

Problem Idea 5: Glue Doesn't Work

Spectacle frames are made of glass and all kinds of plastics and all kinds of metals, it is not likely that any glue can be made which will glue all of these materials. See Reference “Fix It Yourself”

Solution Idea 6: Use Shrink Wrap Tubes

I have access to the “Co-Brain” software, which suggests the alternative “fasten with shrink-wrap” to “fasten with glue”. Maybe you could have a small tube of shrink-wrap in the shape of a soda-straw, fit the lens and spectacles together so that the thin and soft shrink-wrap fits over the broken section of the frame and put the spectacles in the micro-oven for shrinking.

Problem Idea 7: Tubes Don't Fit

The soda straw solution will only work for some lucky cases. Most often the spectacle frame breaks near the arch or the ear attachment and the soda straw solution will not work because the tube will only fit on one side of the broken frame.

Solution Idea 8: Shrink Wrap Entire Frame

(1) Make a larger tube of shrink wrap with a diameter about the size of the frame around the lens, (2) Cut a thin sliver from the end of the tube with scissors in the form of a circular band, (3) Combine the spectacle parts and wrap the band around the broken frame around the lens, and (4) Use a hair dryer or other means to heat the combination.

Problem Idea 9: Lacks Appeal

The color of the shrink-wrap could in some cases look very ugly.

Solution Idea 10: Clear Choice

The shrink-wrap should be transparent.

Problem Idea 11: Unsuitable Plastic

Some shrink-wraps would not be suitable because they are not elastic enough for the fit of the circular band around the broken frame around the lens.

Solution Idea 12: Suitable Plastic

A suitable plastic can be bought from “Doww Chemicals” and is called Chemical X.

Reference: “Doww Plastic Facts”

The idea manager provides a website from which the computer database of ideas can be accessed for viewing and/or for entry of ideas into the computer database. Access to the database usually is over the Internet. A display of the web site provides a menu from which a user may select listings of (a) titles of the most recently contributed ideas; (b) titles of ideas that have received the most hits by users accessing the database; (c) integrated ideas combining the greatest number of prior ideas (such as the individual files respectively providing reference to the greatest number of files that are related either directly or indirectly to the identification code of another idea in the database); (d) the most recent integrated ideas (e) the identification codes of the contributors whom have supplied the most ideas to the database; and (f) the identification codes of the contributors whom have supplied the most ideas to the database for which rights have been provided/transferred. Such listings include links for accessing the ideas listed therein. Users can register for being notified by email of new entries of ideas having selected key words in the idea title and/or text; and such users are then so notified. The email notification includes a link to the new entry in the database.

A contributor enters an idea by text and/or attachment entry and/or by using software downloaded from the idea manager's website, or otherwise provided by the idea manager (such as in a CD), to enter drawings.

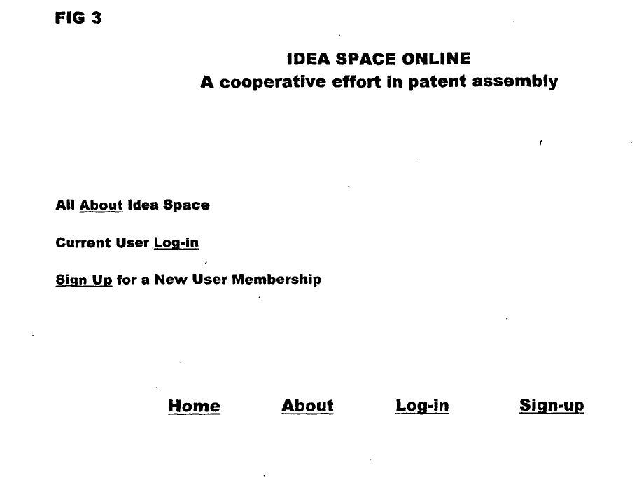

In an exemplary embodiment, the website is named “Idea Space”. The display screens that are provided to a user of the idea database are shown in FIGS. 3 through 54. The underlined portions of the various display screens provide links to either other display screens or to other portions of the display screen then being displayed.

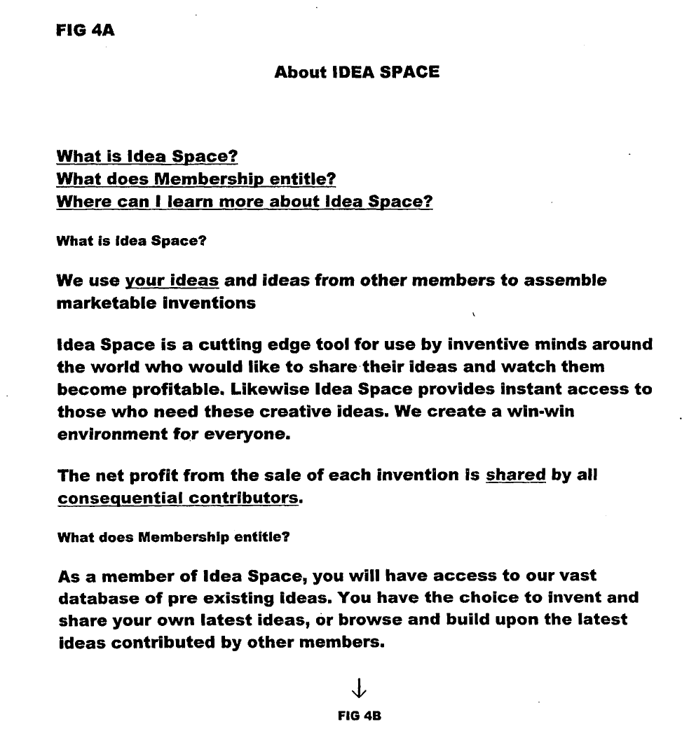

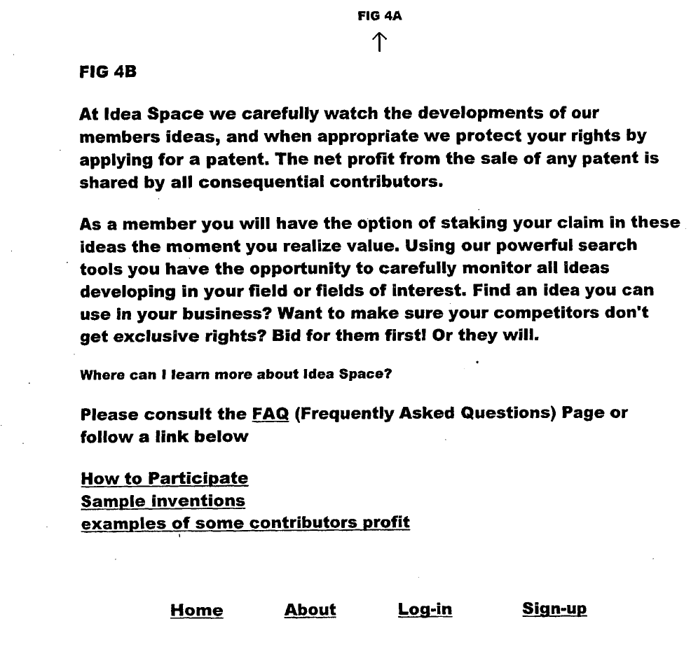

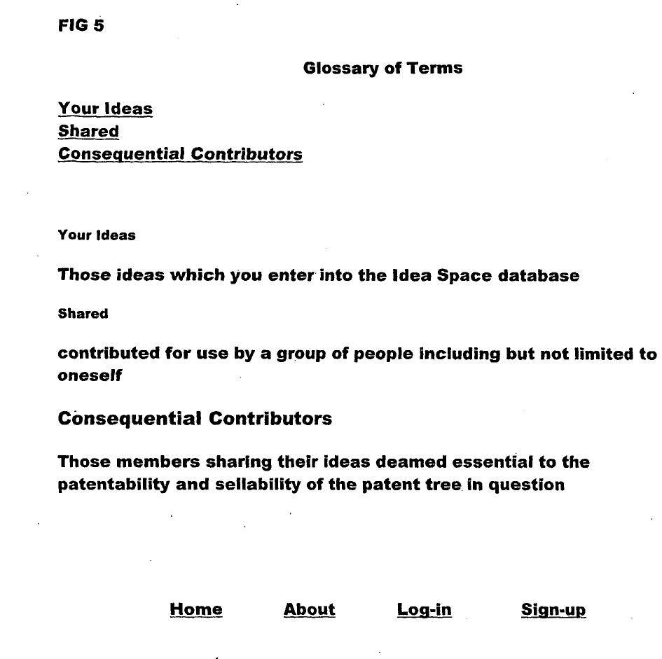

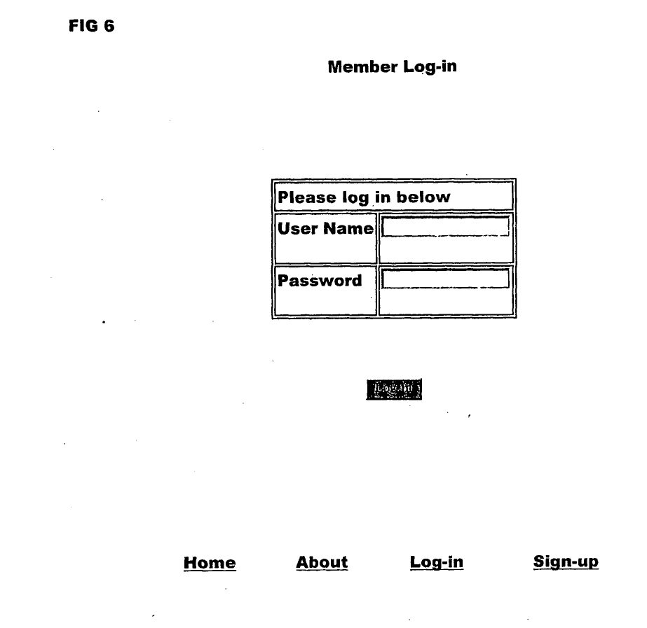

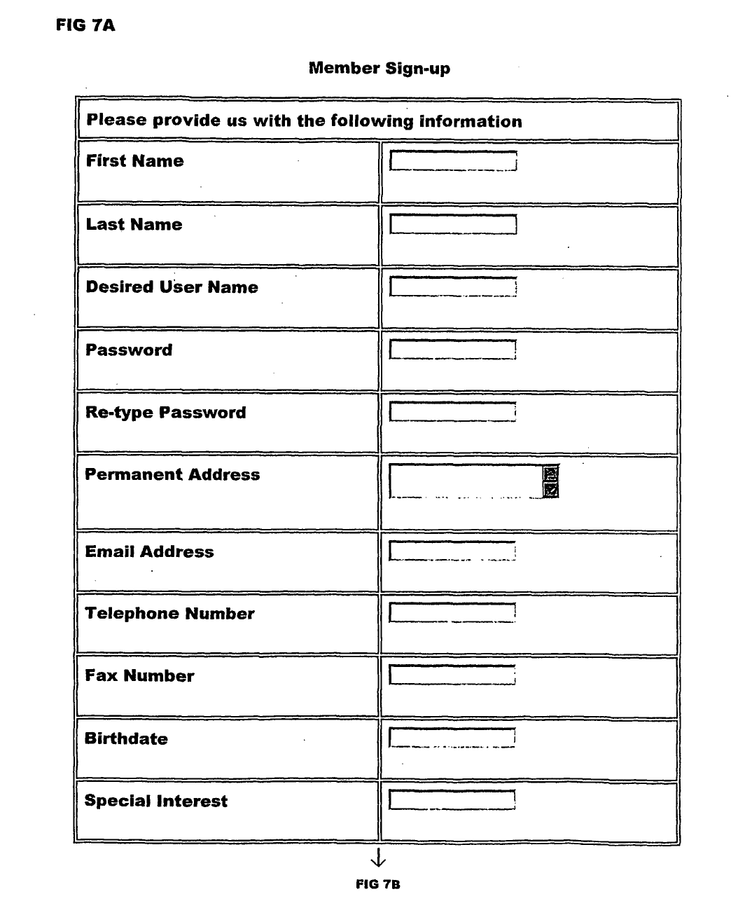

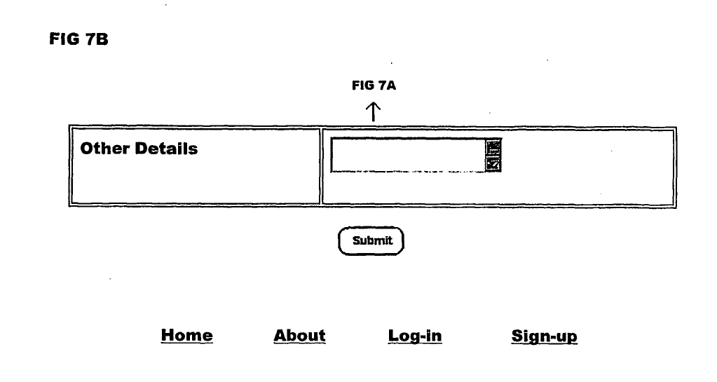

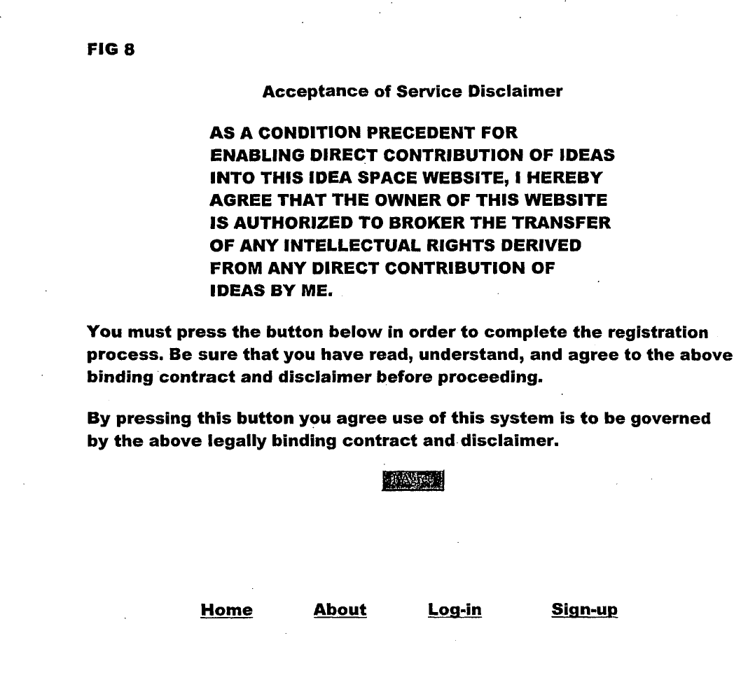

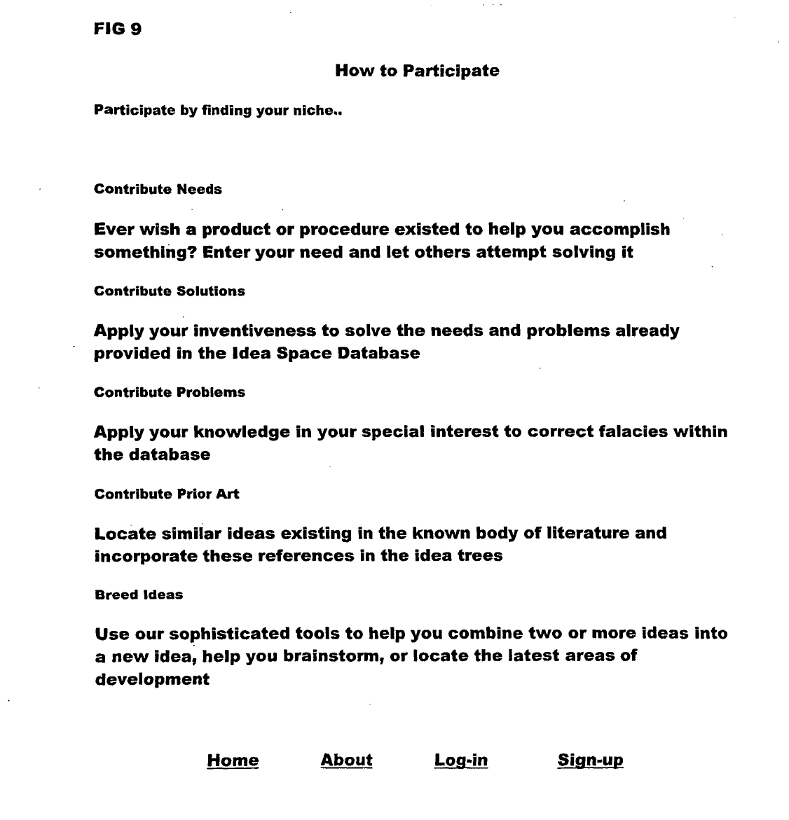

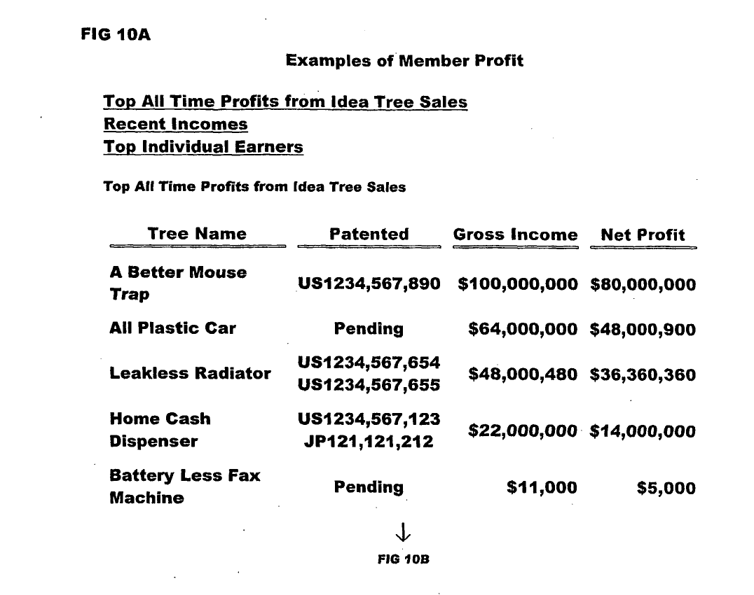

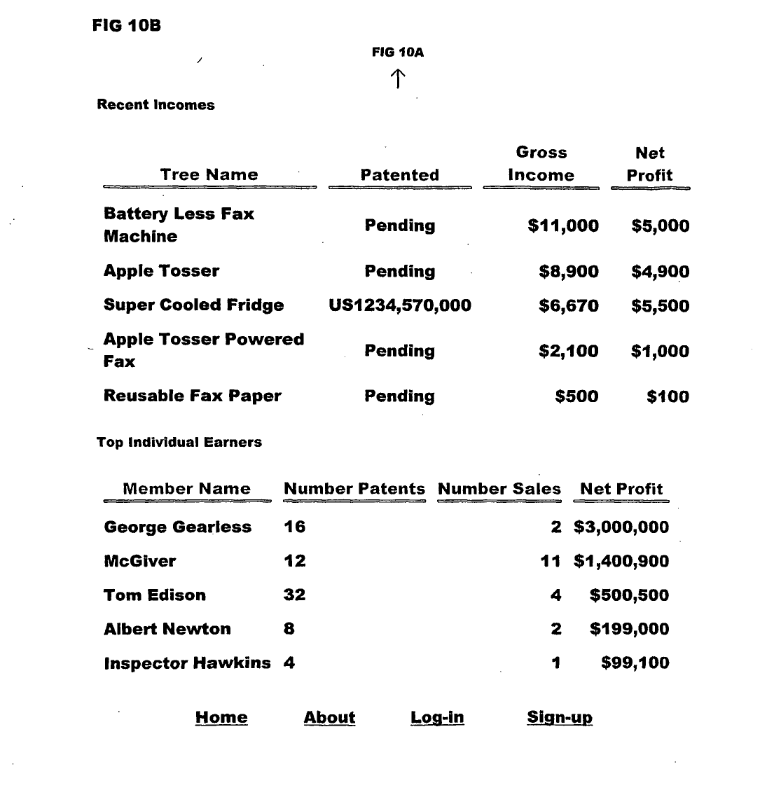

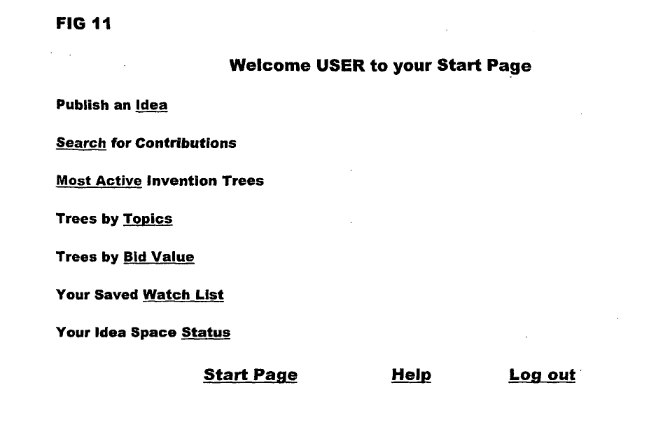

The screen display of the home page of the website is shown in FIG. 3. The home page provides links to the screen displays shown in FIGS. 4, 6 and 7. The underlined text in the “What is Idea Space” section of the “About Idea Space” screen display of FIG. 3 provides links to definitions of the respective underlined text in a “Glossary of Terms” screen display shown in FIG. 5. The “continue” button at the bottom of the “Member Sign-up display screen of FIG. 7 provides a link to the “Acceptance . . . ” display screen shown in FIG. 8. Links to the “How to Participate” display screen of FIG. 9 and the “Examples of Member Profit” display screen of FIG. 10 are provided near the bottom of the “About Idea Space” display screen of FIG. 4.

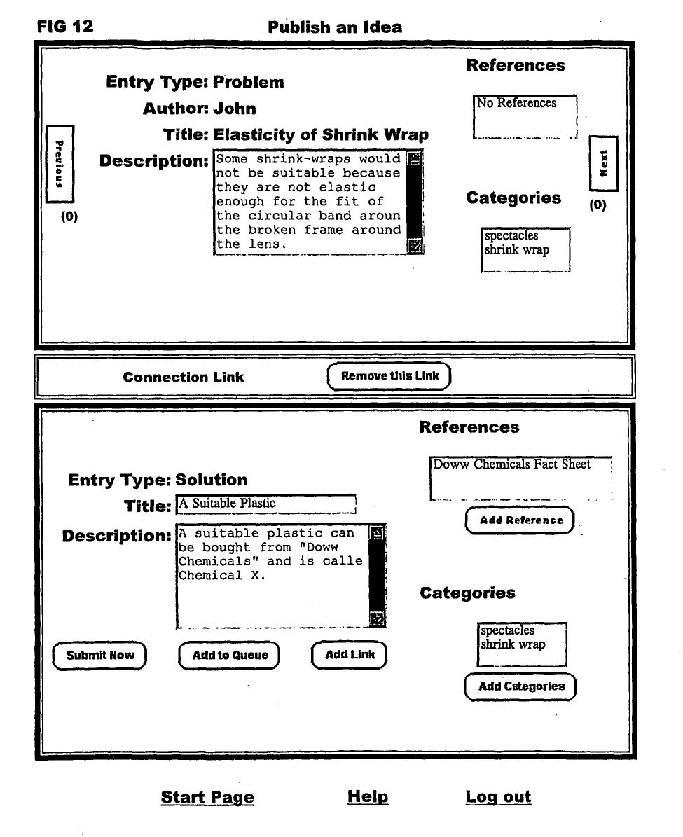

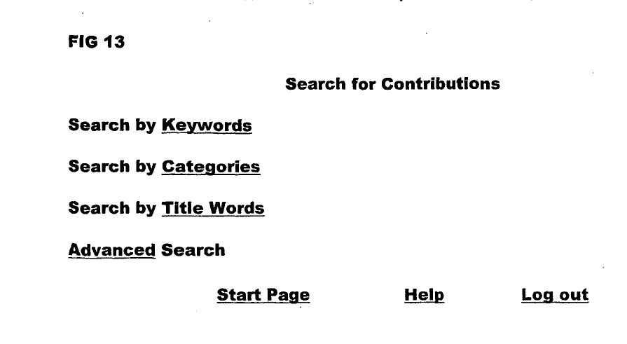

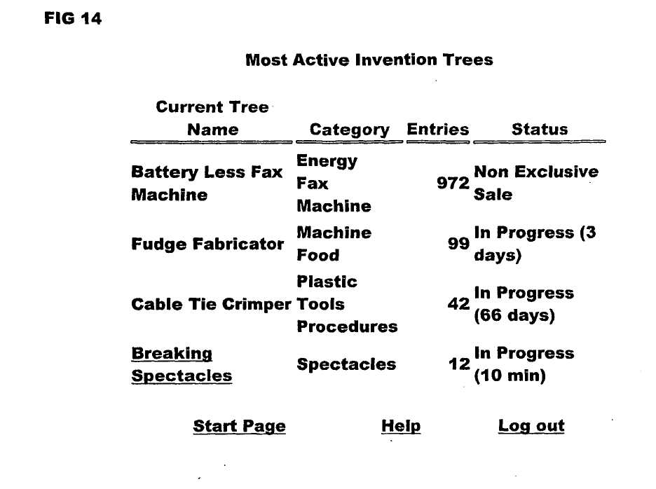

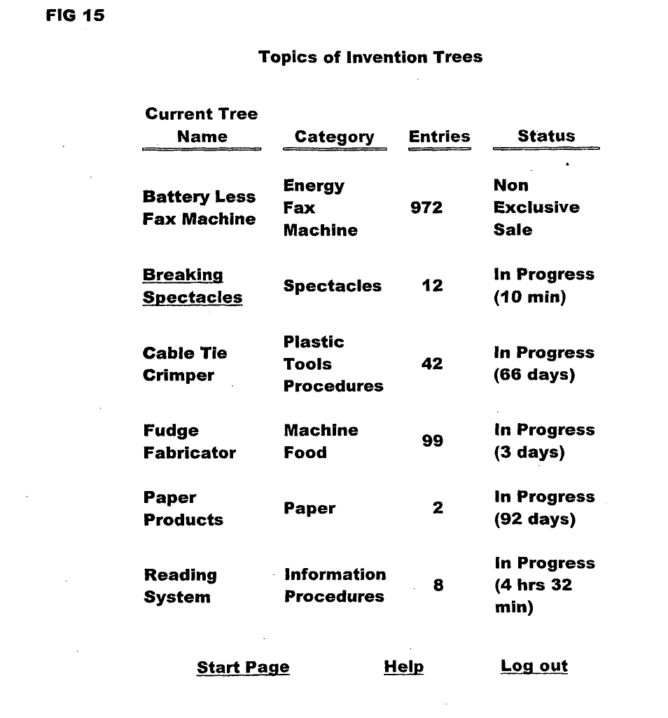

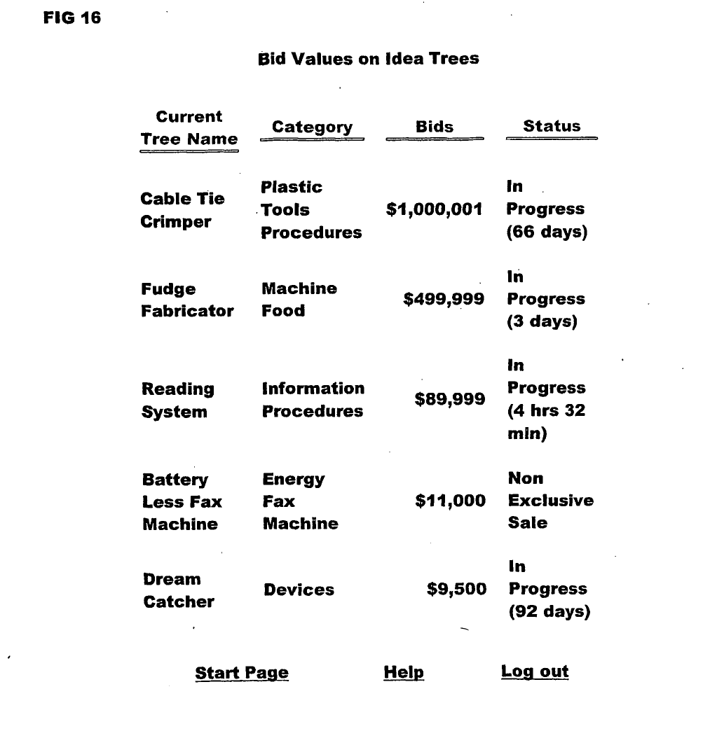

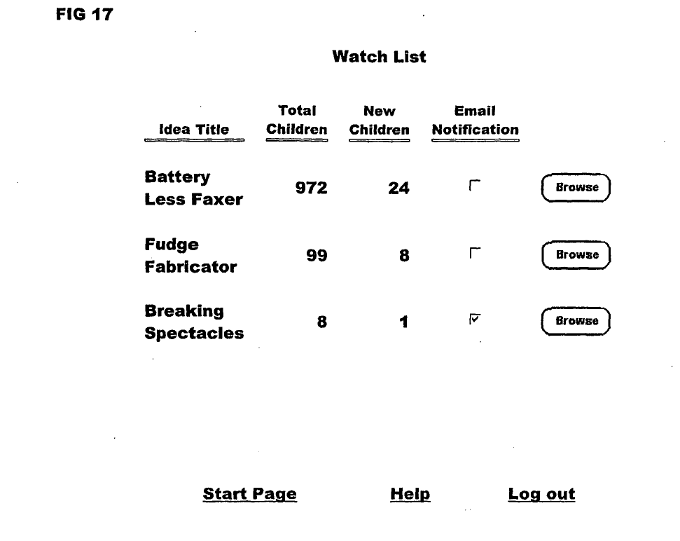

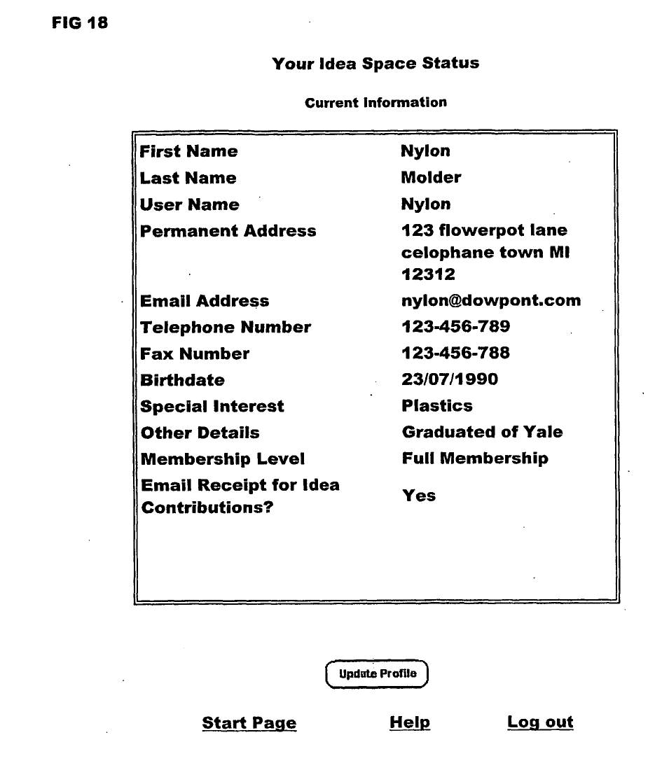

A link to the Start Page screen display of FIG. 11 is provided by the “log in” button on the Member Log-in screen display of FIG. 6. Referring to the Start Page screen display, clicking the “Publish an Idea” link provides the screen display of FIG. 12; clicking the “Search for Contributions” link provides the screen display of FIG. 13; clicking the “Most Active Invention Trees” link provides the screen display of FIG. 14; clicking the “Trees by Topics” link provides the screen display of FIG. 15; clicking the “Trees by Bid Value” link provides the screen display of FIG. 16; clicking the “Your Saved Watch List” link provides the screen display of FIG. 17; and clicking the “Your Idea Space Status” link provides the screen display of FIG. 18.

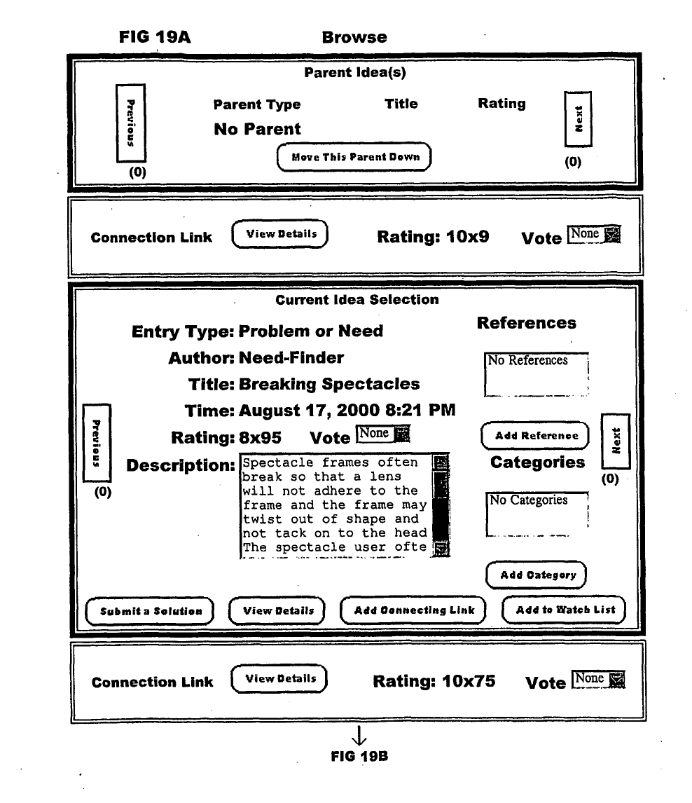

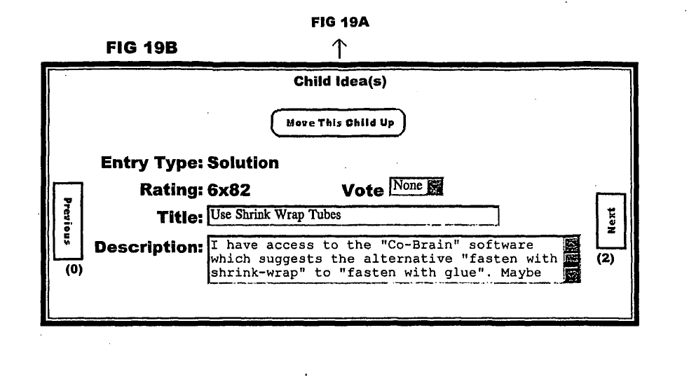

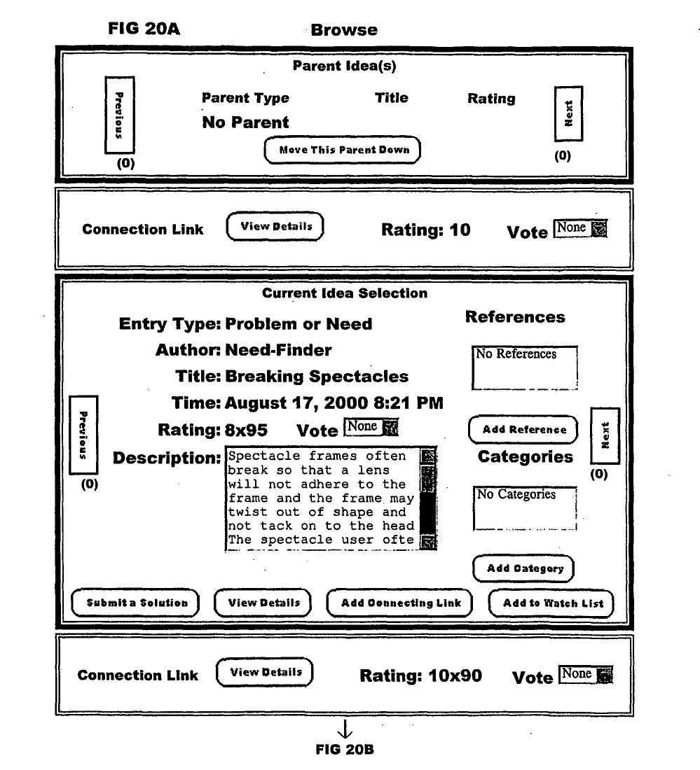

Upon displaying the “Topics of Invention Trees” screen display of FIG. 15, a user can select and browse prior contributions that have been published in the database. The “Breaking Spectacles” link provides access to the exemplary integrated idea described above with reference to FIG. 2, beginning with the screen display of FIG. 19. The format of the screen display for a selected idea (as shown in FIGS. 19-42) includes a “Current Idea Selection” section, a Parent section, a “Child Idea(s)” section, a first “Connection Link” section between the Parent section and the Current Idea Selection section, and a second “Connection Link” section between the Child Idea(s) section and the Current Selection section.

The Current Idea Selection section contains a Description of the selected idea and a Vote window and lists the Entry Type of the selected idea, such as “Problem or Need” or “Solution”; the Author (contributor) of the selected idea, the Title of the selected idea, the Time of publication of the selected idea, a Rating of the appropriateness of the selected idea, any References related to the selected idea, and any Categories related to the selected idea. The Current Idea Selection section also includes Previous and Next buttons for accessing other contributed ideas that are linked to the same parent idea as the selected idea. The quantity of any such other linked contributed ideas are indicated beneath the Previous and Next buttons.

The Parent section contains a Vote window and lists the Type of the linked parent idea, such as “Problem or Need” or “Solution”; the Title of the linked parent idea, and, a Rating of the appropriateness of the linked parent idea. The Parent section also includes Previous and Next buttons for accessing other contributed parent ideas that are linked to the selected idea, and indicates the quantity of any such other linked contributed parent ideas.

The Child Idea(s) section contains a Description of the linked child idea and a Vote window and lists the Entry Type of the linked child idea, such as “Problem or Need” or “Solution”; the Title of the selected idea, and a Rating of the appropriateness of the linked child idea. The Child Idea(s) section also includes Previous and Next buttons for accessing other contributed child ideas that are linked to the selected idea, and indicates the quantity of any such other linked contributed child ideas.

The ratings are provided in response to averaging (or processing by some other formula) the votes by users of the database. Voting is accomplished by selecting a number within a range of 0 to 10 from a drop-down menu displayed by clicking the down-arrow in the Vote window. The listed rating shows the average (or other) rating and the number of voters. Ratings are also listed in the two “Connection Link” sections for the appropriateness of the respective links between the selected idea and either the idea in the Parent section or the idea in the Child Idea(s) section. The ratings provide a user of the database with an immediate indication of the appropriateness of the rated idea or connection link, as voted by other users.

In the screen display of FIG. 19, the selected idea described in the Current Idea Selection section is Problem Idea 1, and the child idea described in the Child Idea(s) section is Solution Idea 6, as described above with reference to FIG. 2. In the Child Idea(s) section, the “(2)” indication beneath the Next button indicates that there are two other child ideas linked to selected Problem Idea 1.

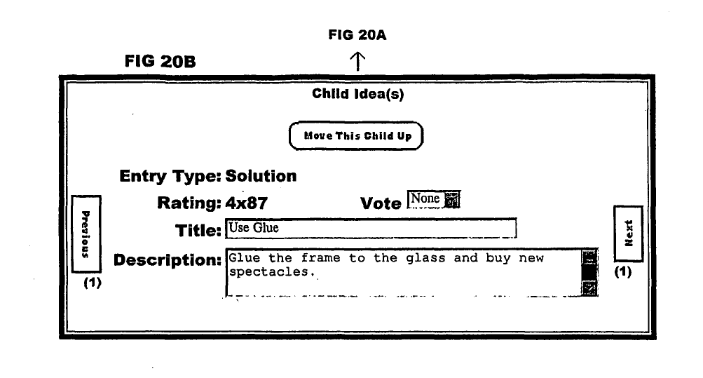

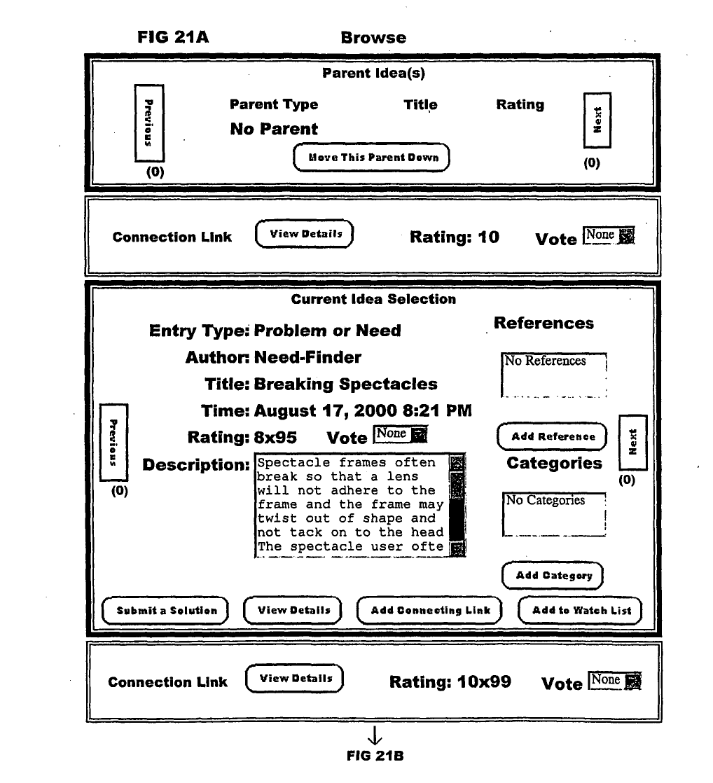

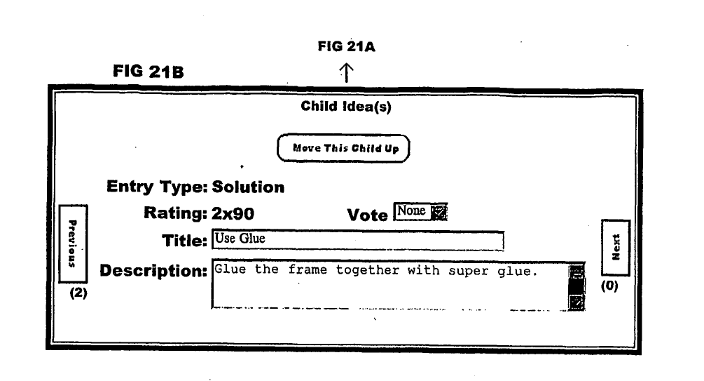

Clicking the Next button in the Child Idea(s) section of the screen display of FIG. 19 provides access to the screen display of FIG. 20, wherein the selected idea described in the Current Idea Selection section is Problem Idea 1, and the child idea described in the Child Idea(s) section is Solution Idea 3, as described above with reference to FIG. 2.

Clicking the Next button in the Child Idea(s) section of the screen display of FIG. 20 provides access-to the screen display of FIG. 21, wherein the selected idea described in the Current Idea Selection section is Problem Idea 1, and the child idea described in the Child Idea(s) section is Solution Idea 2, as described above with reference to FIG. 2.

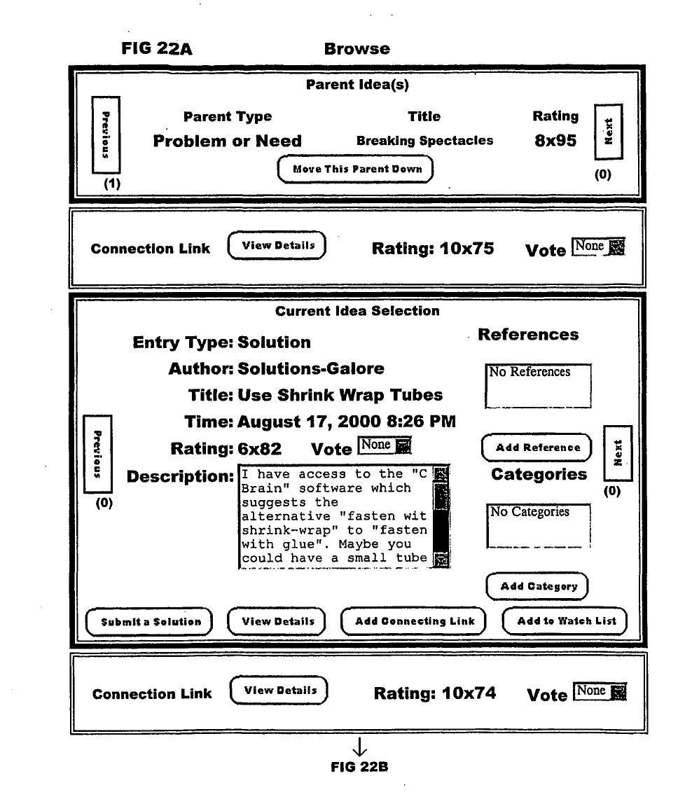

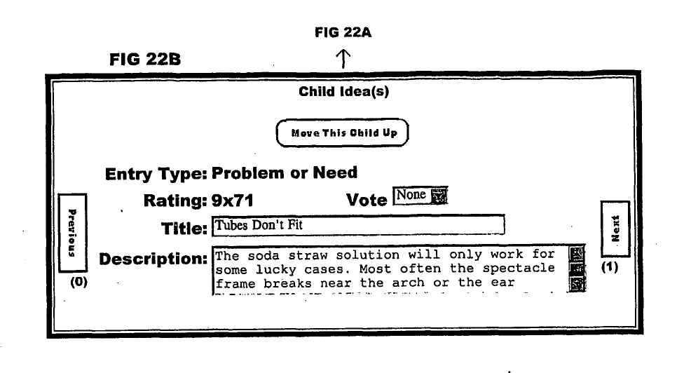

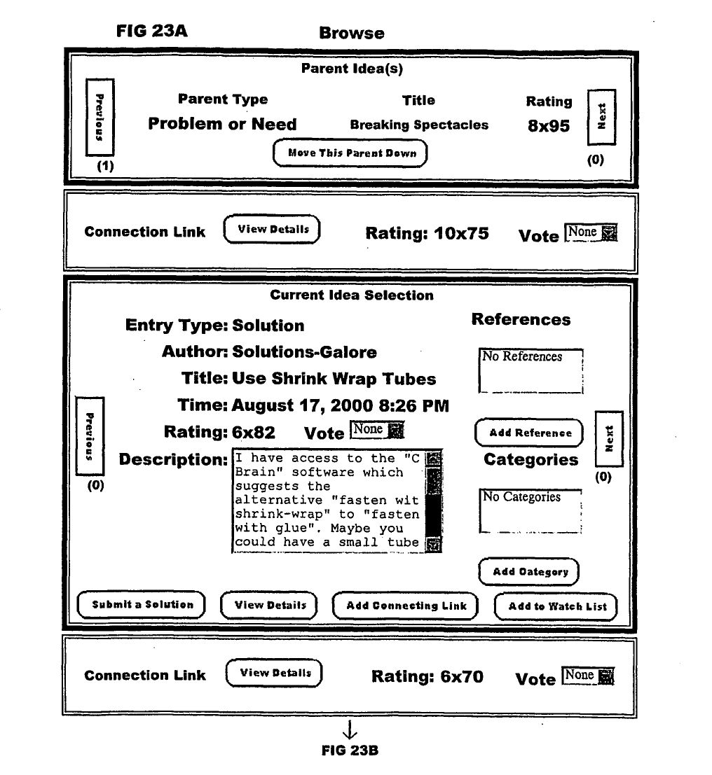

After returning to the initial screen display of FIG. 19, a screen display (as shown in FIG. 22), in which the child idea in the Child Idea(s) section of the screen display of FIG. 19 is displayed as the selected idea in the Current Idea Selection section, is accessed by clicking the “Move This Child Up” button in the Child Idea(s) section, in the screen display of FIG. 19.

In the screen display of FIG. 22, the selected idea described in the Current Idea Selection section is Solution Idea 6, the parent idea listed. in the Parent section is Problem Idea 1, and the child idea described in the Child Idea(s) section is Problem Idea 7, as described above with reference to FIG. 2. In the Child Idea(s) section, the “(1)” indication beneath the Next button indicates that there is one other child idea linked to selected Solution Idea 6.

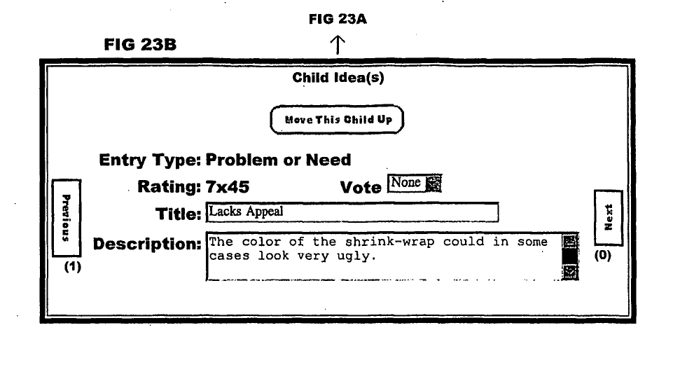

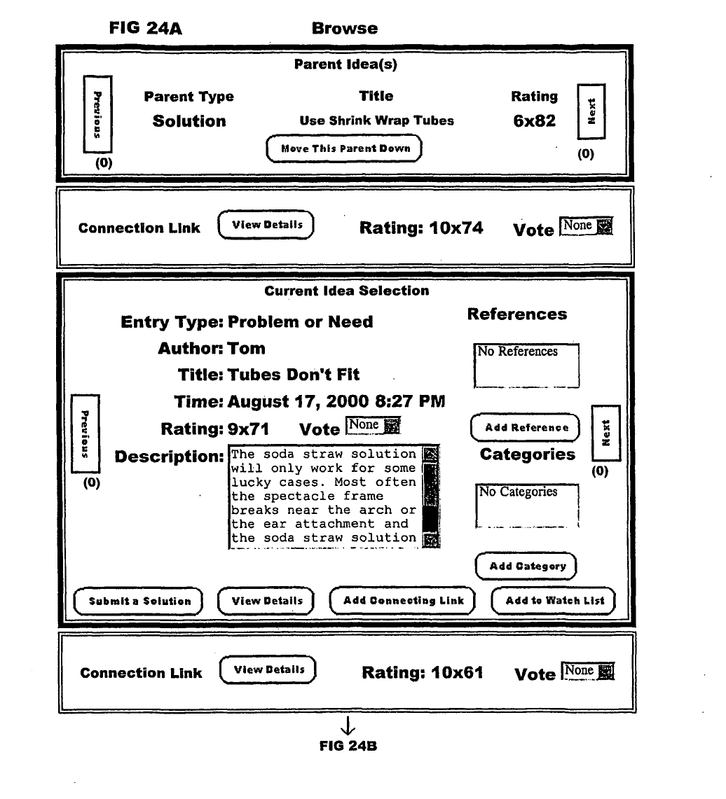

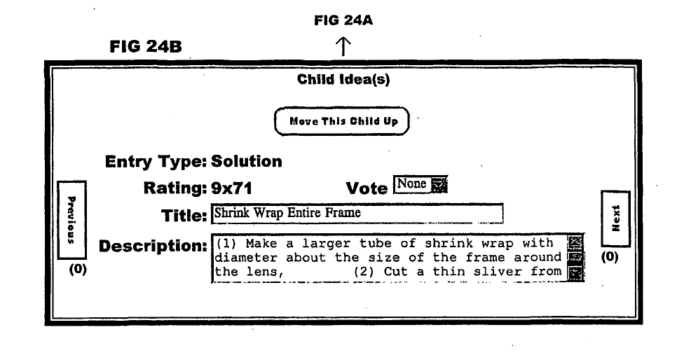

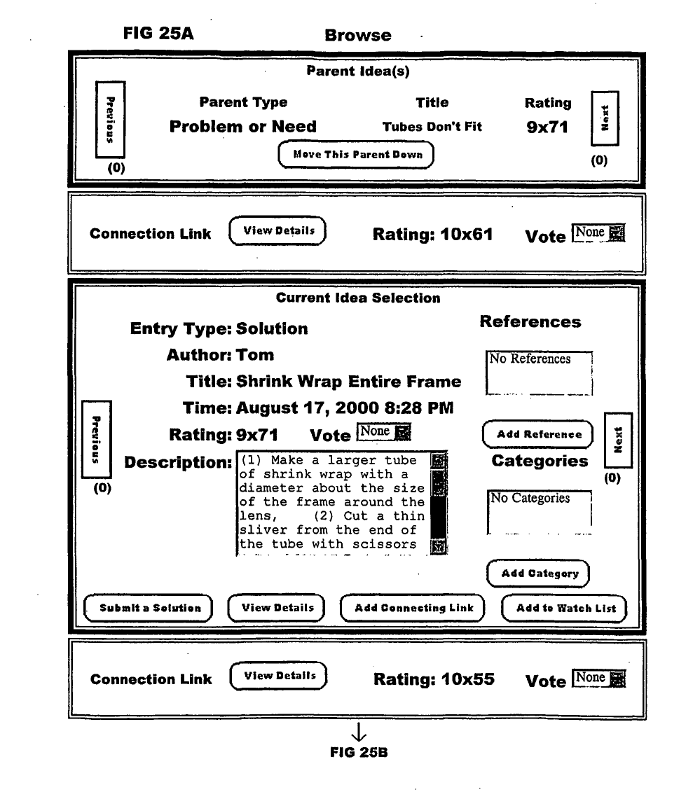

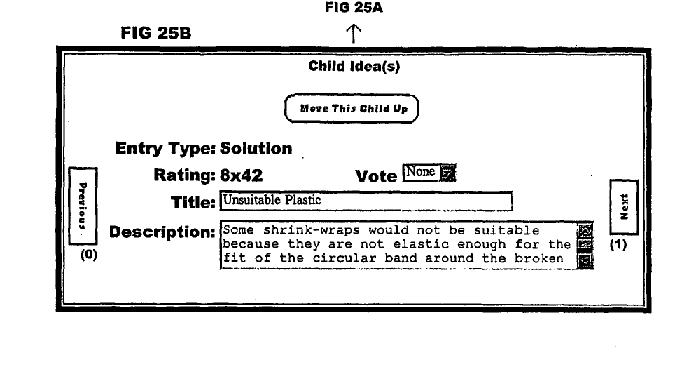

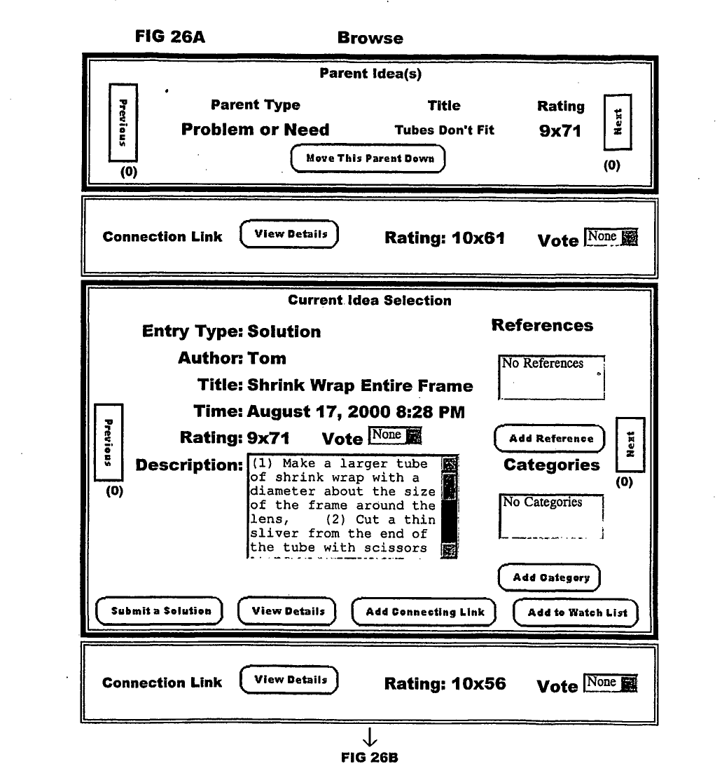

Clicking the Next button in the Child Idea(s) section of the screen display of FIG. 22 provides access to the screen display of FIG. 23, wherein the selected idea described in the Current Idea Selection section is Solution Idea 6, the parent idea listed in the Parent section is Problem Idea 1, and the child idea described in the Child Idea(s) section is Problem Idea 9, as described above with reference to FIG. 2.

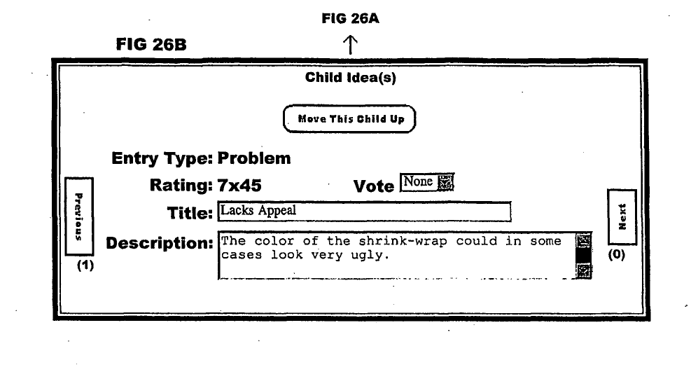

After returning to the screen display of FIG. 22, a screen display (as shown in FIG. 24), in which the child idea in the Child Idea(s) section of the screen display of FIG. 22 is displayed as the selected idea in the Current Idea Selection section, is accessed by clicking the “Move This Child Up” button in the Child Idea(s) section, in the screen display of FIG. 22.

In the screen display of FIG. 24, the selected idea described in the Current Idea Selection section is Problem Idea 7, the parent idea listed in the Parent section is Solution Idea 6, and the child idea described in the Child Idea(s) section is Solution Idea 8, as described above with reference to FIG. 2. In the Child Idea(s) section, the “(0)” indication beneath the Next button indicates that there are no other child ideas linked to selected Problem Idea 7.

A screen display (as shown in FIG. 25), in which the child idea in the Child Idea(s) section of the screen display of FIG. 24 is displayed as the selected idea in the Current Idea Selection section, is accessed by clicking the “Move This Child Up” button in the Child Idea(s) section, in the screen display of FIG. 24.

In the screen display of FIG. 25, the selected idea described in the Current Idea Selection section is Solution Idea 8, the parent idea listed in the Parent section is Problem Idea 7, and the child idea described in the Child Idea(s) section is Problem Idea 11, as described above with reference to FIG. 2. In the Child Idea(s) section, the “(1)” indication beneath the Next button indicates that there is one other child idea linked to selected Solution Idea 8.

Clicking the Next button in the Child Idea(s) section of the screen display of FIG. 25 provides access to the screen display of FIG. 26, wherein the selected idea described in the Current Idea Selection section is Solution Idea 8, the parent idea listed in the Parent section is Problem Idea 7, and the child idea described in the Child Idea(s) section is Problem Idea 9, as described above with reference to FIG. 2.

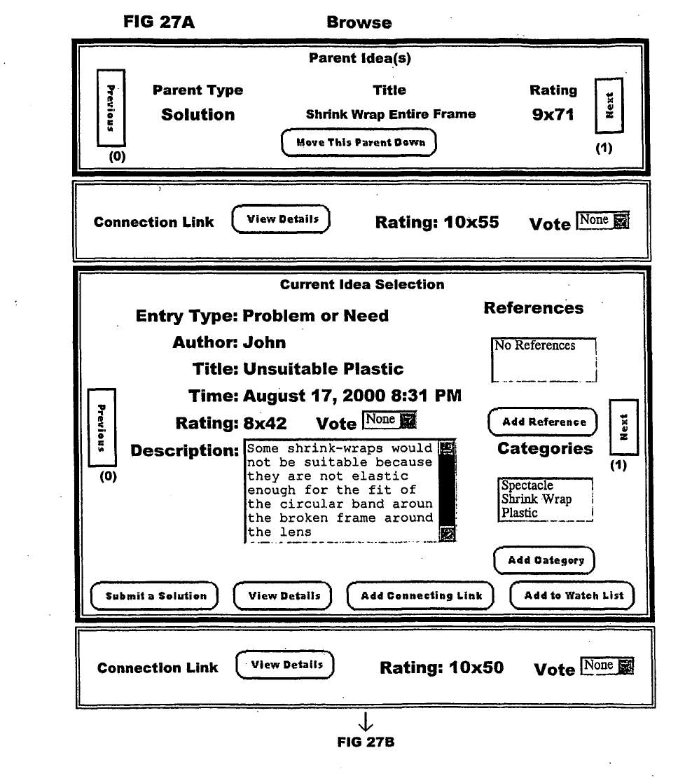

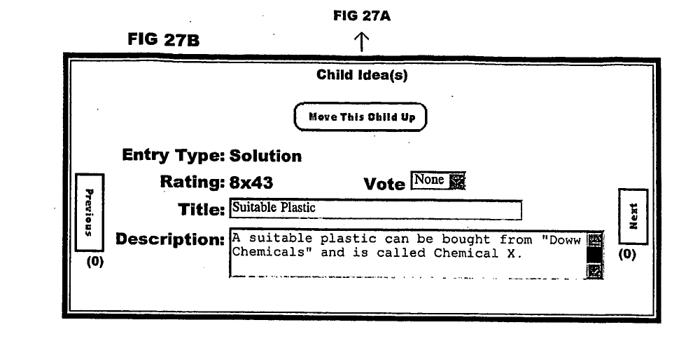

After returning to the screen display of FIG. 25, a screen display (as shown in FIG. 27), in which the child idea in the Child Idea(s) section of the screen display of FIG. 25 is displayed as the selected idea in the Current Idea Selection section, is accessed by clicking the “Move This Child Up” button in the Child Idea(s) section, in the screen display of FIG. 25.

In the screen display of FIG. 27, the selected idea described in the Current Idea Selection section is Problem Idea 11, the parent idea listed in the Parent section is Solution Idea 8, and the child idea described in the Child Idea(s) section is Solution Idea 12, as described above with reference to FIG. 2. In the Child Idea(s) section, the “(0)” indication beneath the Next button indicates that there are no other child ideas linked to selected Problem Idea 11.

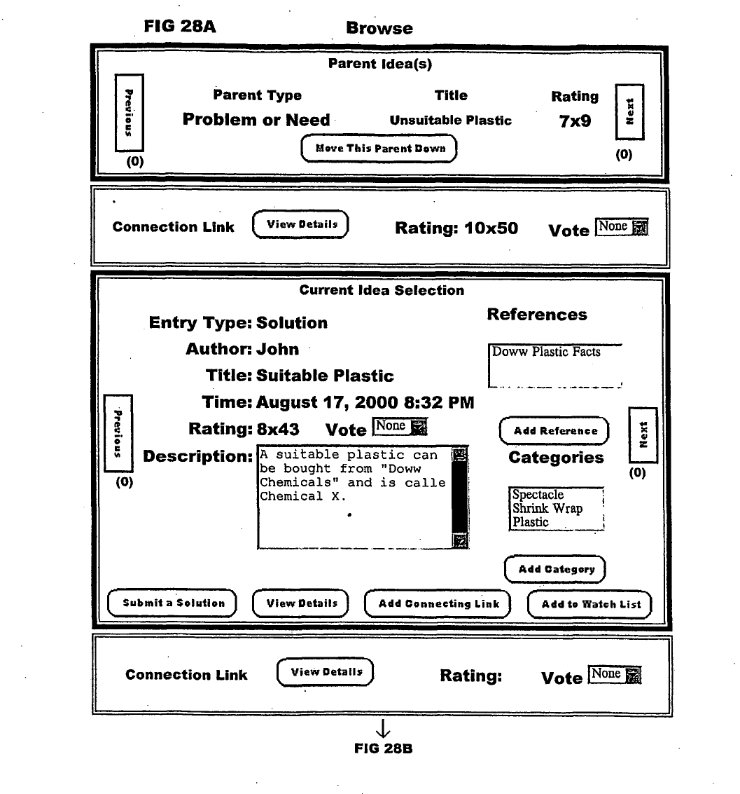

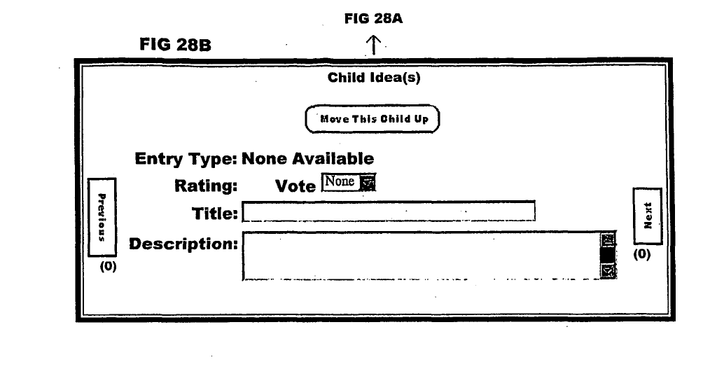

A screen display (as shown in FIG. 28), in which the child idea in the Child Idea(s) section of the screen display of FIG. 27 is displayed as the selected idea in the Current Idea Selection section, is accessed by clicking the “Move This Child Up” button in the Child Idea(s) section, in the screen display of FIG. 27.

In the screen display of FIG. 28, the selected idea described in the Current Idea Selection section is Solution Idea 12, the parent idea listed in the Parent section is Problem Idea 11, and no child idea described in the Child Idea(s) section.

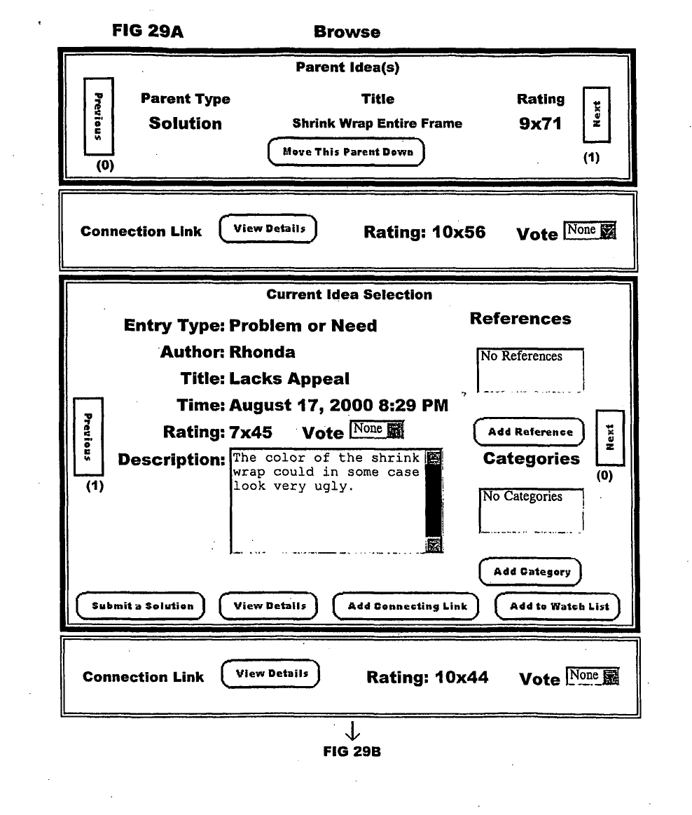

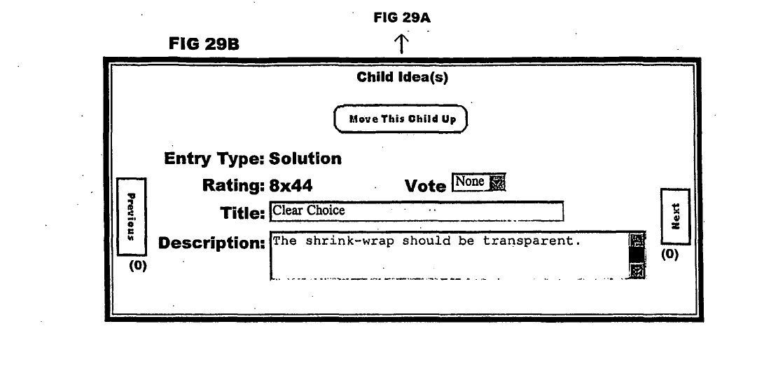

After returning to the screen display of FIG. 26, a screen display (as shown in FIG. 29), in which the child idea in the Child Idea(s) section of the screen display of FIG. 26 is displayed as the selected idea in the Current Idea Selection section, is accessed by clicking the “Move This Child Up” button in the Child Idea(s) section, in the screen display of FIG. 26.

In the screen display of FIG. 29, the selected idea described in the Current Idea Selection section is Problem Idea 9, the parent idea listed in the Parent section is Solution Idea 8, and the child idea described in the Child Idea(s) section is Solution Idea 10, as described above with reference to FIG. 2. In the Child Idea(s) section, the “(0)” indication beneath the Next button indicates that there are no other child ideas linked to selected Problem Idea 9. In the Parent section, the “(1)” indication beneath the Next button indicates that there is one other parent idea linked to selected Problem Idea 9.

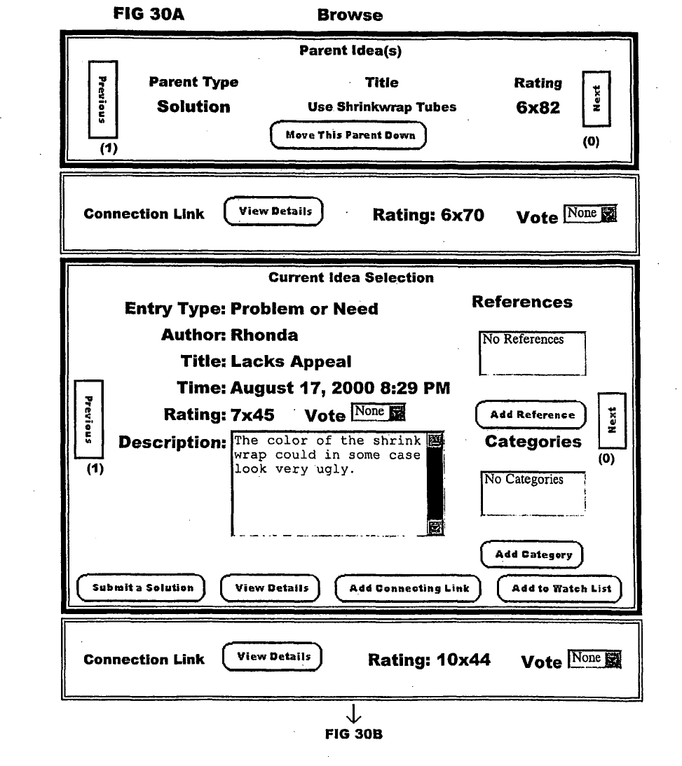

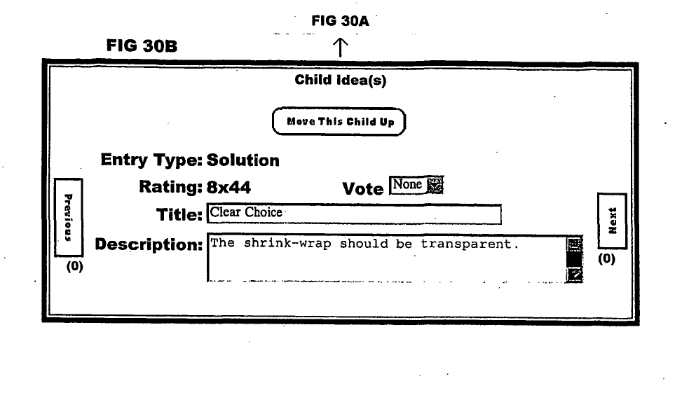

Clicking the Next button in the Parent section of the screen display of FIG. 29 provides access to the screen display of FIG. 30, wherein the selected idea described in the Current Idea Selection section is Problem Idea 9, the parent idea listed in the Parent section is Problem Idea 6, and the child idea described in the Child Idea(s) section is Solution Idea 10.

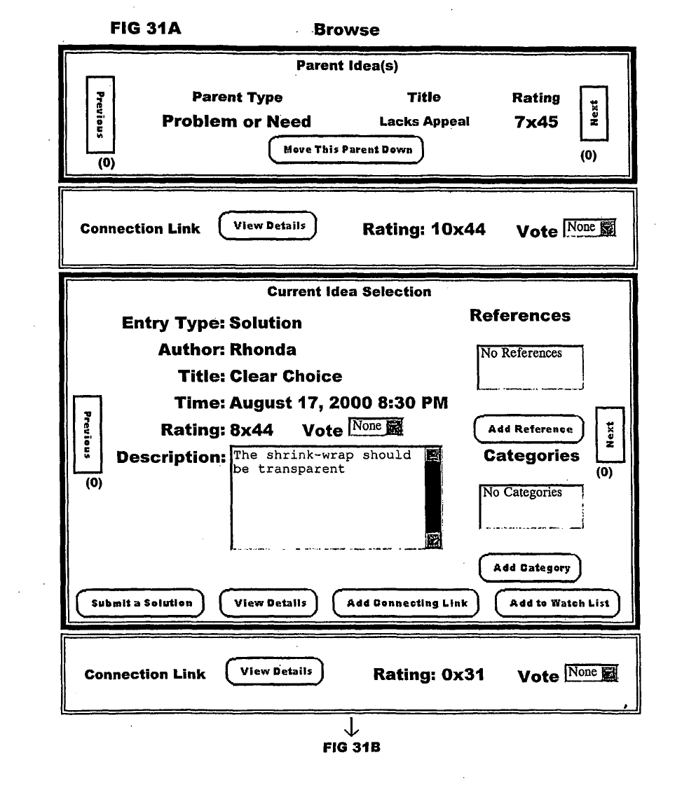

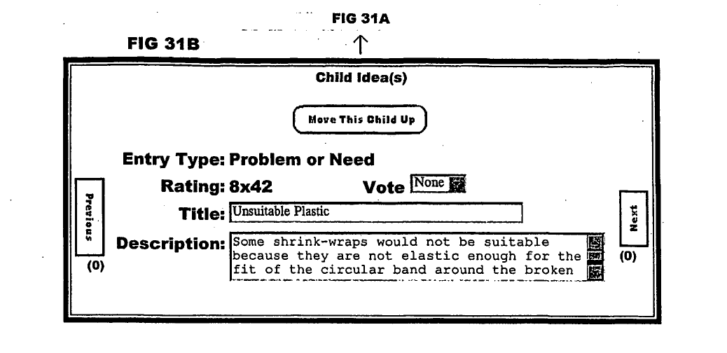

A screen display (as shown in FIG. 31), in which the child idea in the Child Idea(s) section of the screen display of FIG. 30 is displayed as the selected idea in the Current Idea Selection section, is accessed by clicking the “Move This Child Up” button in the Child Idea(s) section, in the screen display of FIG. 30.

In the screen display of FIG. 31, the selected idea described in the Current Idea Selection section is Solution Idea 10, the parent idea listed in the Parent section is Problem Idea 9, and the child idea described in the Child Idea(s) section is Problem Idea 11.

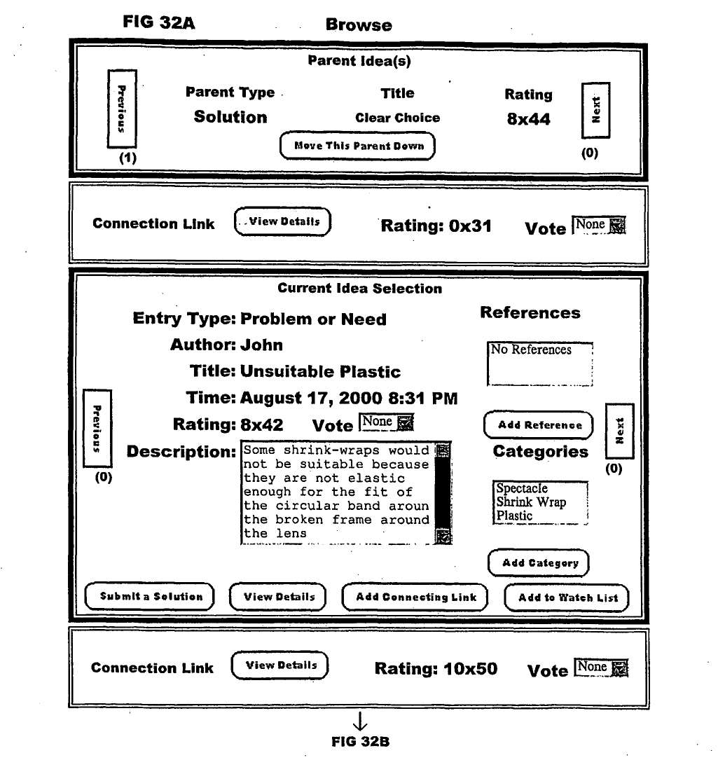

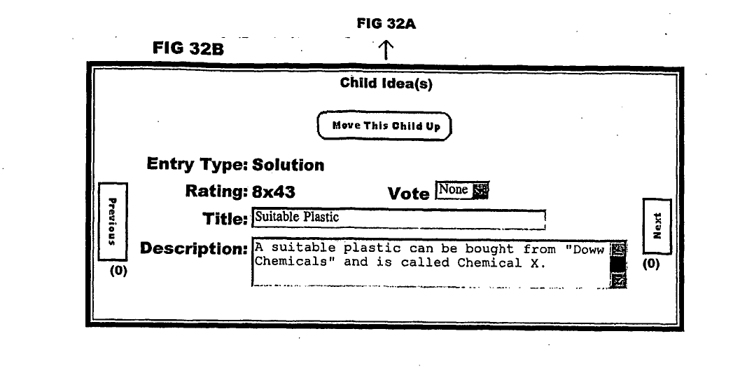

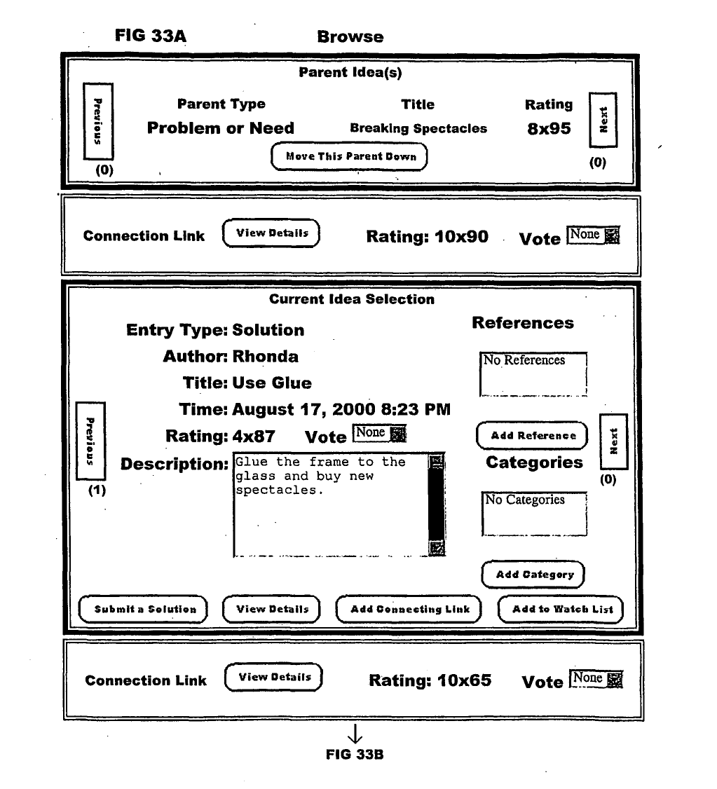

A screen display (as shown in FIG. 32), in which the child idea in the Child Idea(s) section of the screen display of FIG. 31 is displayed as the selected idea in the Current Idea Selection section, is accessed by clicking the “Move This Child Up” button in the Child Idea(s) section, in the screen display of FIG. 31.

In the screen display of FIG. 32, the selected idea described in the Current Idea Selection section is Problem Idea 11, the parent idea listed in the Parent section is Solution Idea 10, and the child idea described in the Child Idea(s) section is Solution Idea 12.

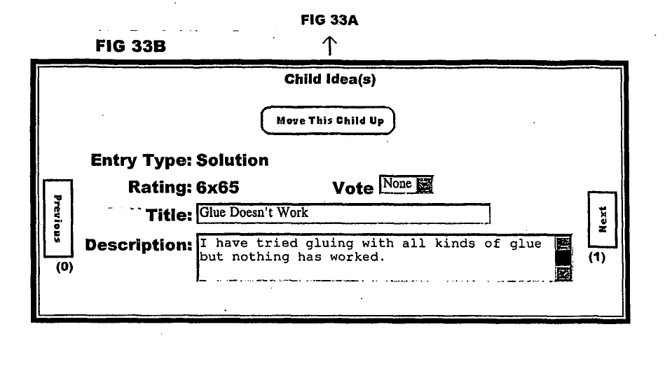

After returning to the screen display of FIG. 20, a screen display (as shown in FIG. 33), in which the child idea in the Child Idea(s) section of the screen display of FIG. 20 is displayed as the selected idea in the Current Idea Selection section, is accessed by clicking the “Move This Child Up” button in the Child Idea(s) section, in the screen display of FIG. 20.

In the screen display of FIG. 33, the selected idea described in the Current Idea Selection section is Solution Idea 3, the parent idea listed in the Parent section is Problem Idea 1, and the child idea described in the Child Idea(s) section is Problem Idea 4, as described above with reference to FIG. 2. In the Child Idea(s) section, the “(1)” indication beneath the Next button indicates that there is one other child idea linked to selected Solution Idea 3.

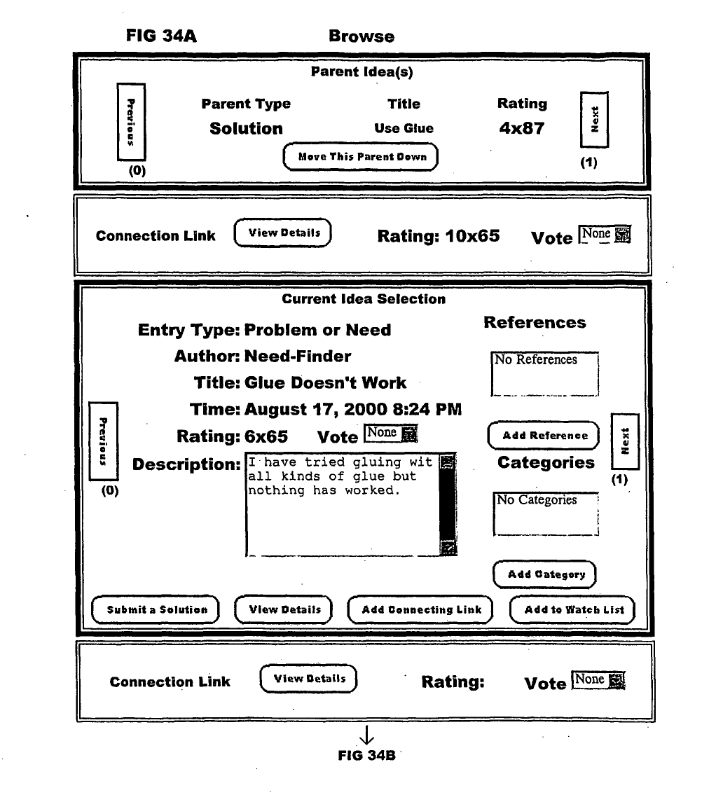

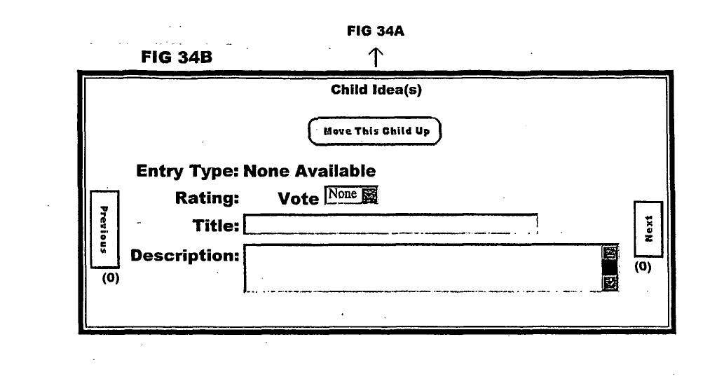

A screen display (as shown in FIG. 34), in which the child idea in the Child Idea(s) section of the screen display of FIG. 33 is displayed as the selected idea in the Current Idea Selection section, is accessed by clicking the “Move This Child Up” button in the Child Idea(s) section, in the screen display of FIG. 33.

In the screen display of FIG. 34, the selected idea described in the Current Idea Selection section is Problem Idea 4, the parent idea listed in the Parent section is Solution Idea 3, and no child idea described in the Child Idea(s) section.

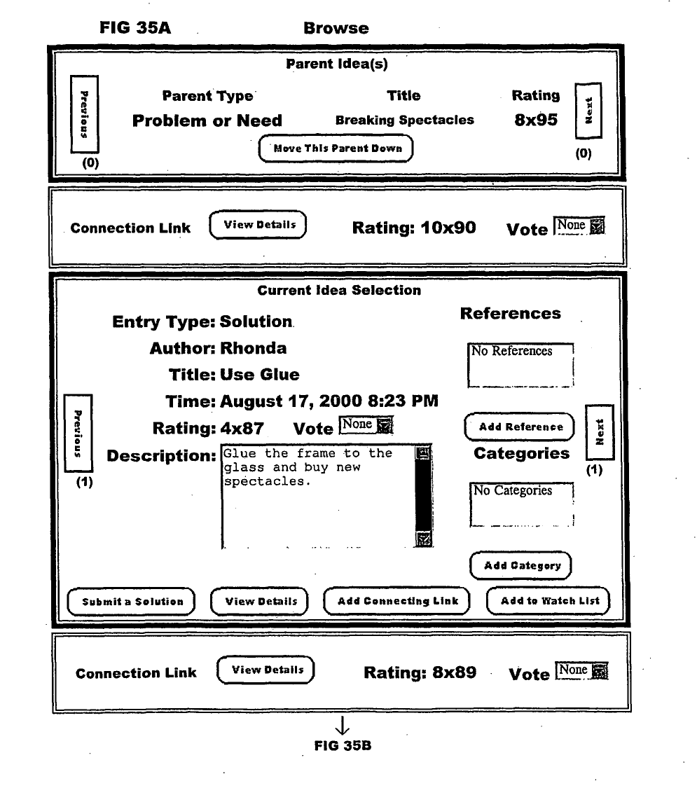

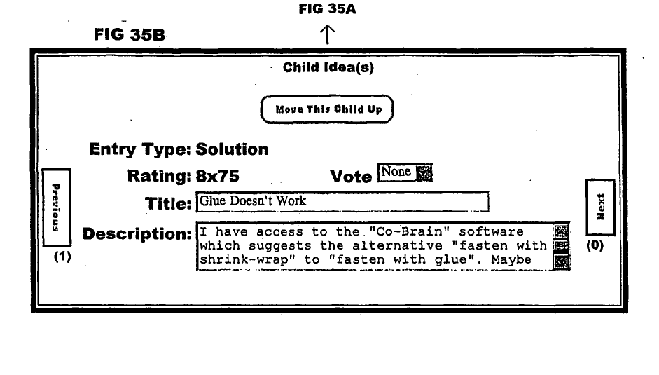

After returning to the screen display of FIG. 33, clicking the Next button in the Child Idea(s) section of the screen display of FIG. 33 provides access to the screen display of FIG. 35, wherein the selected idea described in the Current Idea Selection section is Solution Idea 3, the parent idea listed in the Parent section is Problem Idea 1, and the child idea described in the Child Idea(s) section is Problem Idea 5, as described above with reference to FIG. 2.

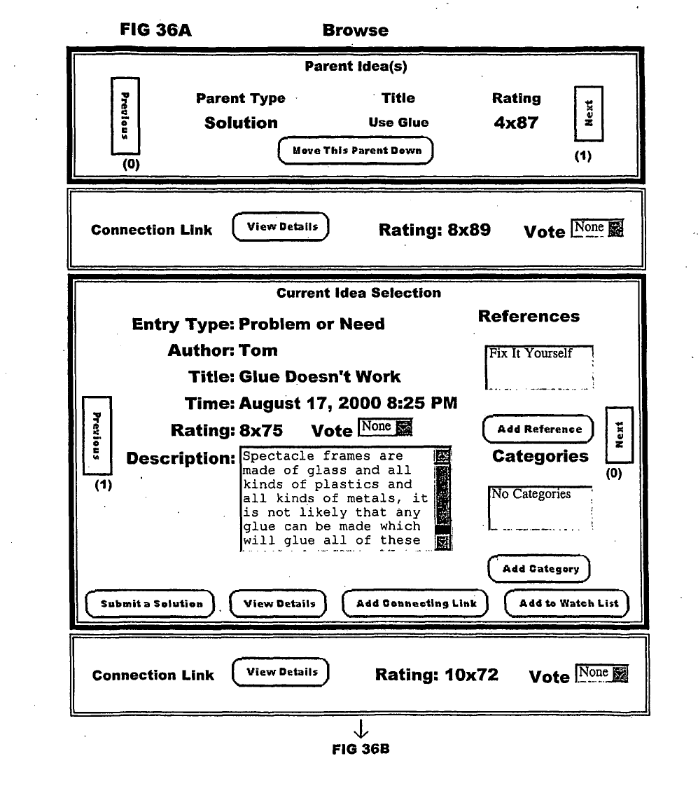

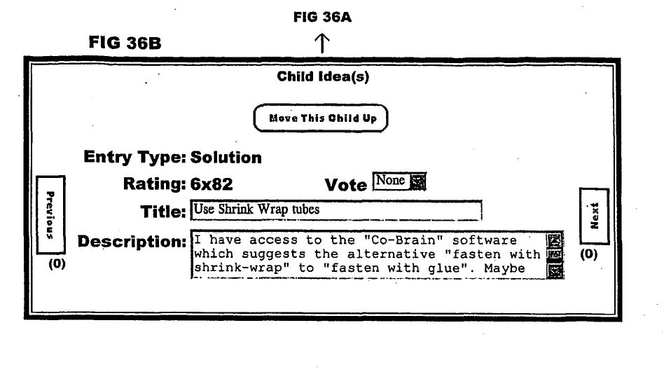

A screen display (as shown in FIG. 36), in which the child idea in the Child Idea(s) section of the screen display of FIG. 35 is displayed as the selected idea in the Current Idea Selection section, is accessed by clicking the “Move This Child Up” button in the Child Idea(s) section, in the screen display of FIG. 35.

In the screen display of FIG. 36, the selected idea described in the Current Idea Selection section is Problem Idea 5, the parent idea listed in the Parent section is Solution Idea 3, and Solution Idea 6 is child idea described in the Child Idea(s).

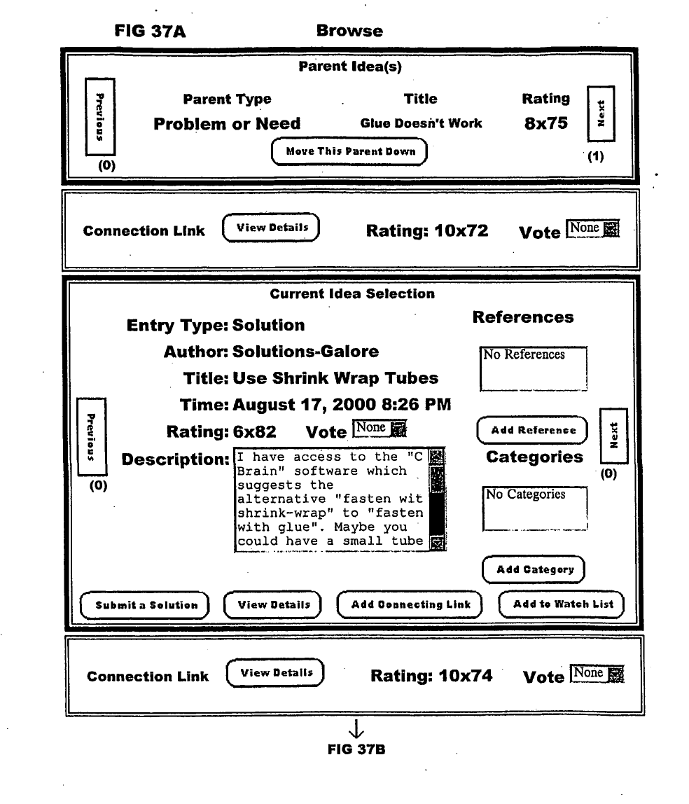

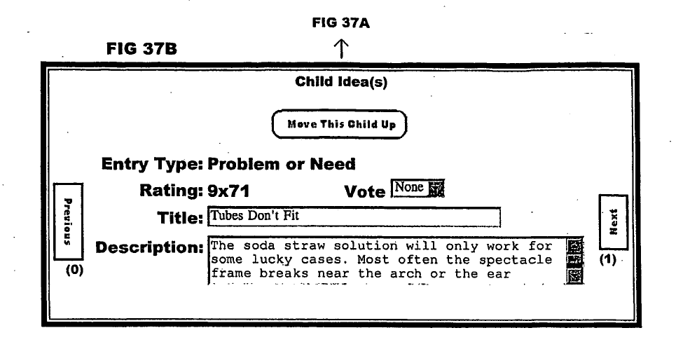

A screen display (as shown in FIG. 37), in which the child idea in the Child Idea(s) section of the screen display of FIG. 36 is displayed as the selected idea in the Current Idea Selection section, is accessed by clicking the “Move This Child Up” button in the Child Idea(s) section, in the screen display of FIG. 36.

In the screen display of FIG. 37, the selected idea described in the Current Idea Selection section is Solution Idea 6, the parent idea listed in the Parent section is Problem Idea 5, and the child idea described in the Child Idea(s) section is Problem Idea 7. In the Child Idea(s) section, the “(1)” indication beneath the Next button indicates that there is one other child idea linked to selected Solution Idea 6.

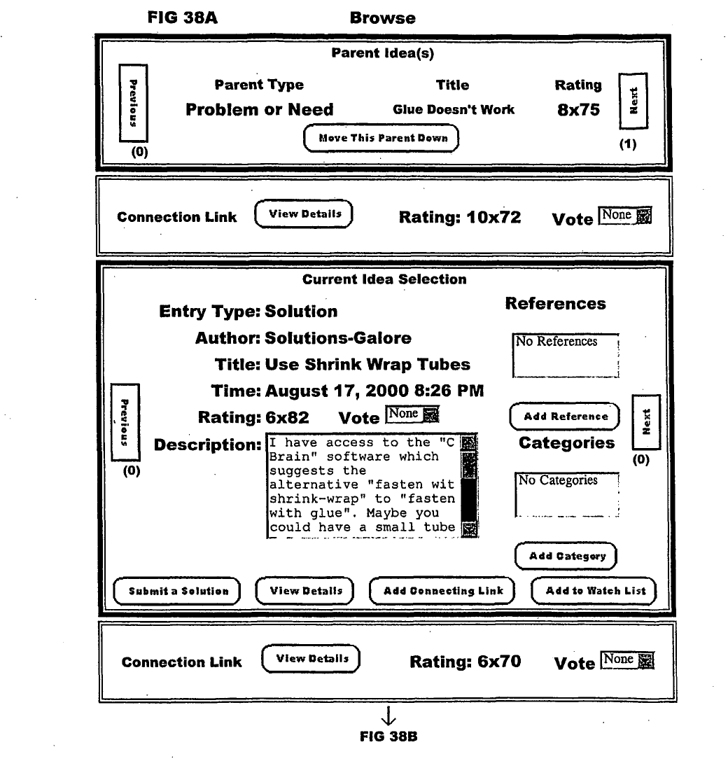

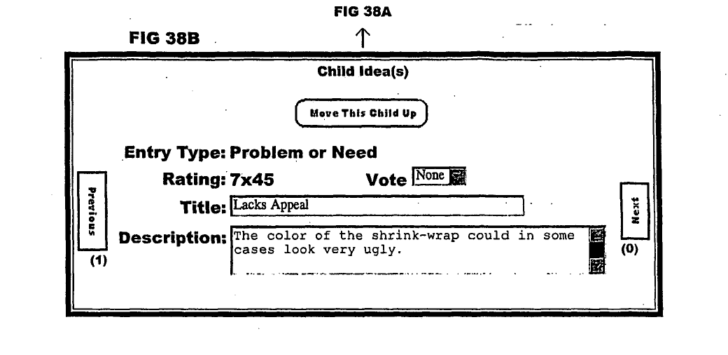

Clicking the Next button in the Child Idea(s) section of the screen display of FIG. 37 provides access to the screen display of FIG. 38, wherein the selected idea described in the Current Idea Selection section is Solution Idea 6, the parent idea listed in the Parent section is Problem Idea 5, and the child idea described in the Child Idea(s) section is Problem Idea 9.

After returning to the screen display of FIG. 21, a screen display (as shown in FIG. 39), in which the child idea in the Child Idea(s) section of the screen display of FIG. 21 is displayed as the selected idea in the Current Idea Selection section, is accessed by clicking the “Move This Child Up” button in the Child Idea(s) section, in the screen display of FIG. 21.

In the screen display of FIG. 39, the selected idea described in the Current Idea Selection section is Solution Idea 2, the parent idea listed in the Parent section is Problem Idea 1, and the child idea described in the Child Idea(s) section is Problem Idea 4. In the Child Idea(s) section, the “(1)” indication beneath the Next button indicates that there is one other child idea linked to selected Solution Idea 2.

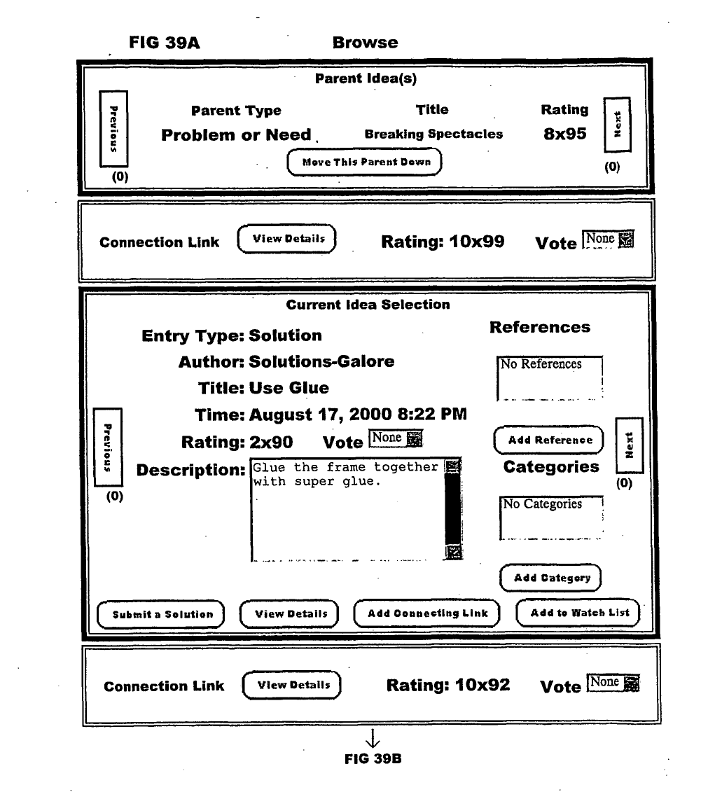

A screen display (as shown in FIG. 40), in which the child idea in the Child Idea(s) section of the screen display of FIG. 39 is displayed as the selected idea in the Current Idea Selection section, is accessed by clicking the “Move This Child Up” button in the Child Idea(s) section, in the screen display of FIG. 39.

In the screen display of FIG. 40, the selected idea described in the Current Idea Selection section is Problem Idea 4, the parent idea listed in the Parent section is Solution Idea 2, and no child idea described in the Child Idea(s) section.

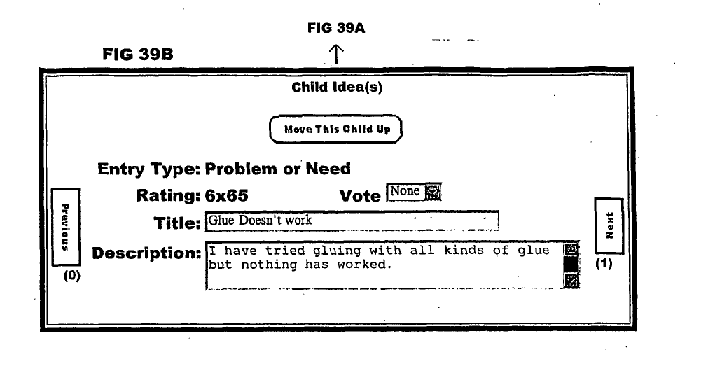

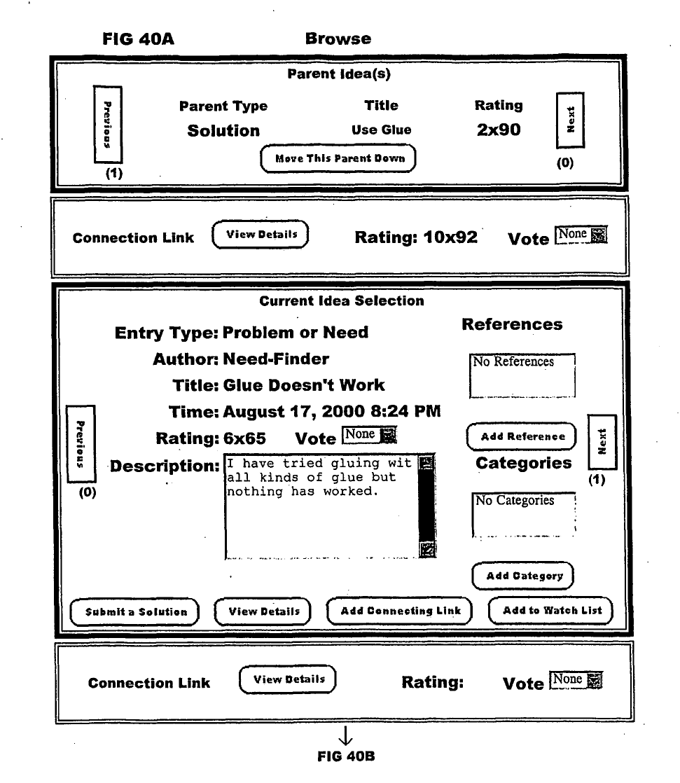

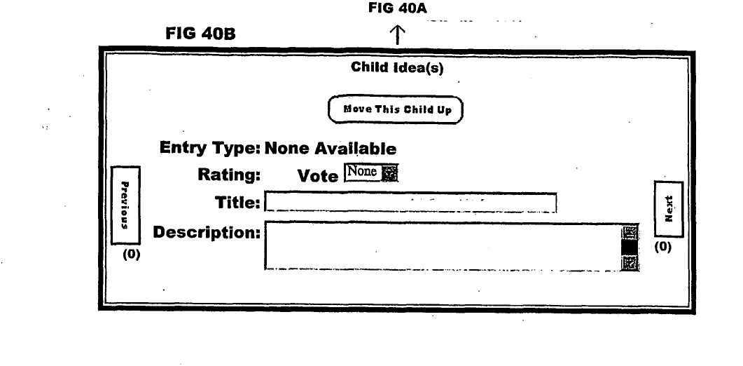

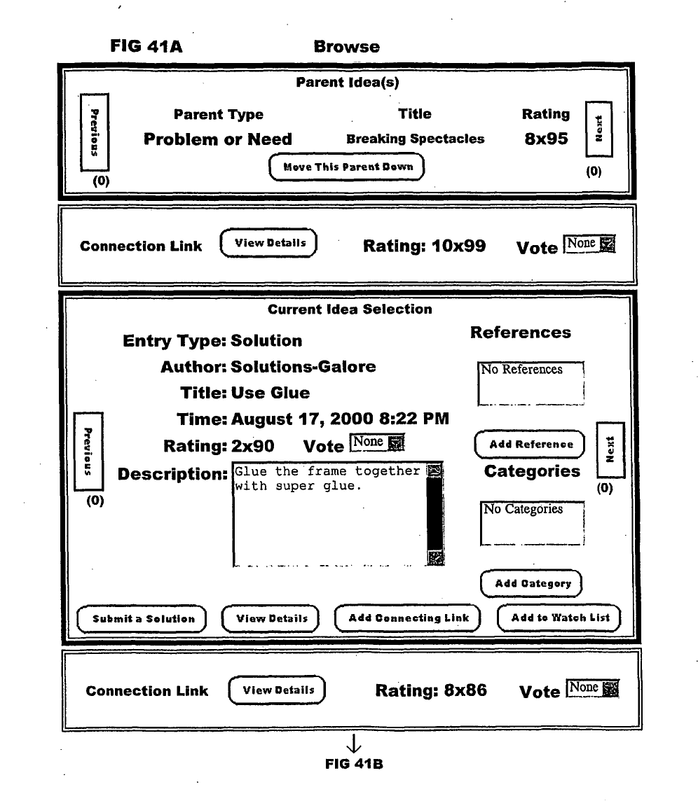

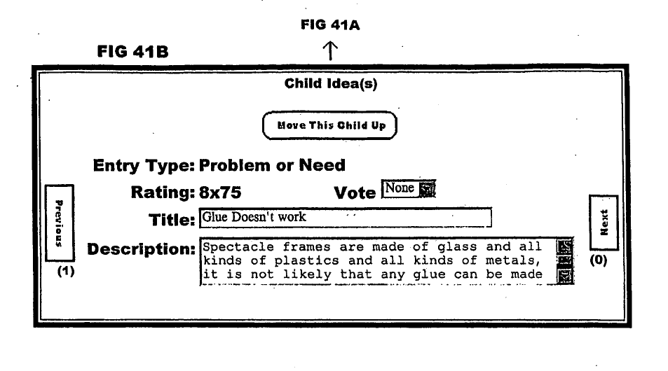

After returning to screen display of FIG. 39, clicking the Next button in the Child Idea(s) section of the screen display of FIG. 39 provides access to the screen display of FIG. 41, wherein the selected idea described in the Current Idea Selection section is Solution Idea 2, the parent idea listed in the Parent section is Problem Idea 1, and the child idea described in the Child Idea(s) section is Problem Idea 5.

A screen display (as shown in FIG. 42), in which the child idea in the Child Idea(s) section of the screen display of FIG. 41 is displayed as the selected idea in the Current Idea Selection section, is accessed by clicking the “Move This Child Up” button in the Child Idea(s) section, in the screen display of FIG. 41.

In the screen display of FIG. 42, the selected idea described in the Current Idea Selection section is Problem Idea 5, the parent idea listed in the Parent section is Solution Idea 2, and the child idea described in the Child Idea(s) section is Solution Idea 6.

In the same manner, clicking the “Parent down” button moves the display of the parent down into the Current Idea Selection section.

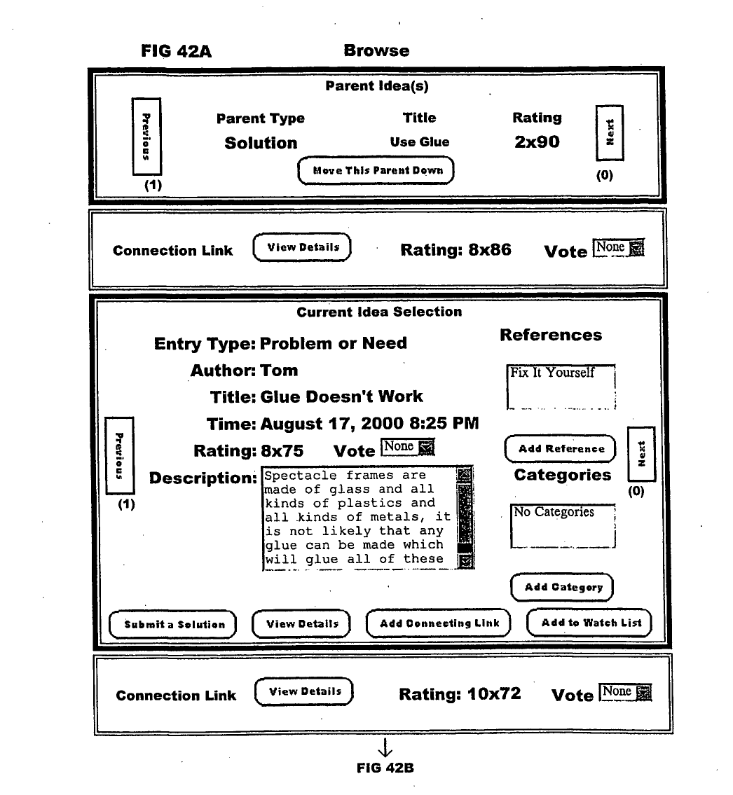

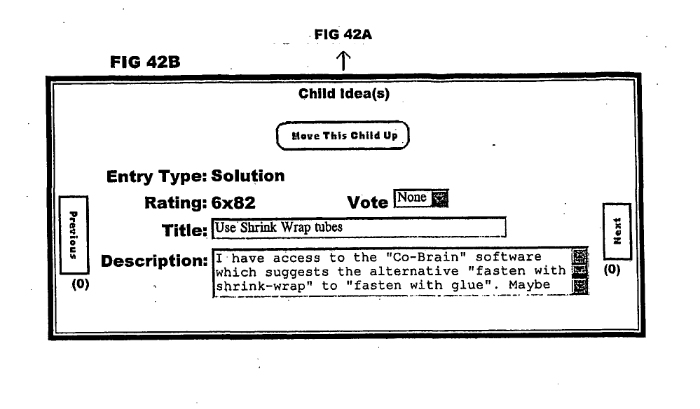

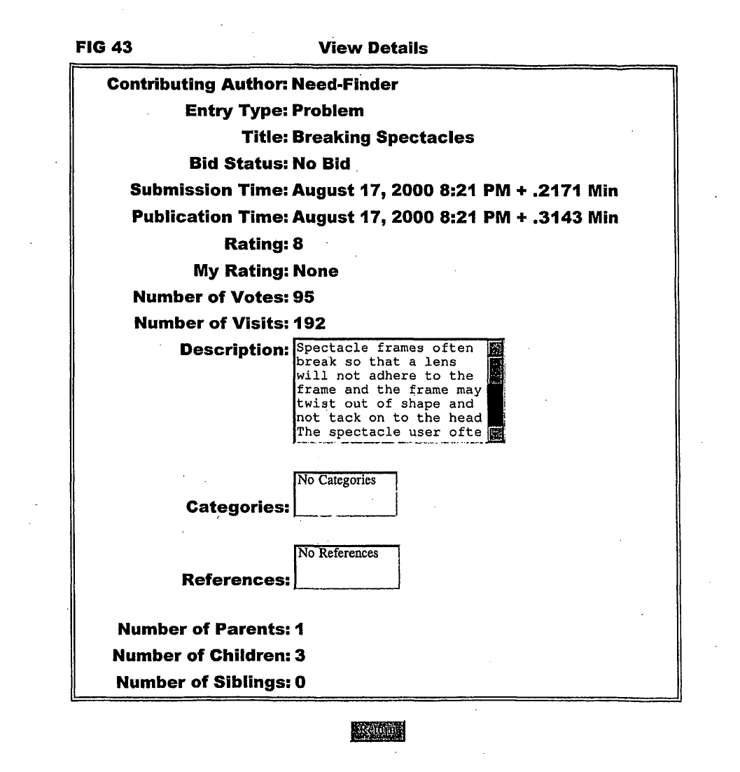

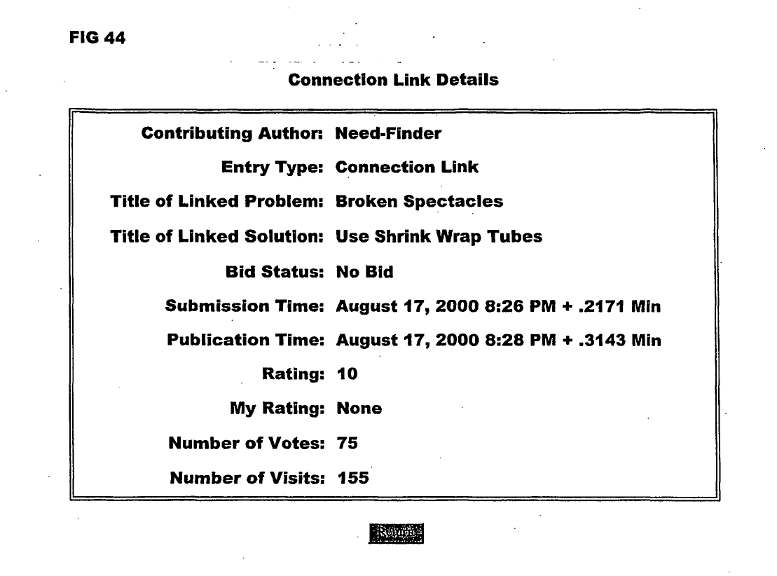

Referring again to the format of the screen display for a selected idea, as shown in FIG. 19, clicking the View Details button in the Current Idea Selection section provides access to the screen display of FIG. 43, which recites various details related to the selected idea in the Current Idea Selection section; and clicking the View Details button in the Connection Link section between the Current Idea Selection section and the Child Idea(s) section provides access to the screen display of FIG. 44, which recites various details related to the idea in the Child Idea(s) section.

The Publish an Idea screen display of FIG. 12 includes an upper section for describing a first idea, a lower section for describing a second idea and a Connection Link section. The first idea is linked to the second idea unless the link is removed by clicking the “Remove this Link” button in the Connection link section. The display in the upper section corresponds to the Current Idea Selection section of a browse-mode display screen, such as shown in FIG. 19. Text is manually entered into the Title and Description portions of the lower section. The entered text may be added to a queue for submission with other entries by clicking the Add to Queue button in the lower section.

The queue is a storage area of scratch book for members of the Idea Space website to store and organize sets of contributed ideas and sets of connection links before they are submitted to the Idea Space database. Contributed ideas and connecting links may then be submitted as a unit in a member-organized configuration. Connection links within the queue may connect two contributed ideas within the queue, two currently published contributed ideas within the database, or a contributed idea within the queue and a currently published contributed idea within the database. Until submitted to the database individually or as a part of a unit in a member-organized configuration, the idea files in the queue and/or their organization within one or more units, as defined by their connection links, may be modified, deleted, moved, or recombined by the user/member. New contributed ideas and connection links may be added to the queue. Means are provided for selecting contributed ideas and connection links for submission to the database as an organized unit or individually. Submission to the database is not limited by the order in which the contributed ideas and the connection links are created. Contributed ideas and connection links in the queue that are not submitted when other contributed ideas and connection links in the queue are submitted are saved for later manipulation and/or submission to the idea database. The computer system managing the Idea Space website database does not process or publish contributed ideas or related connection links until the entire unit containing the contributed ideas and the related connection links is submitted. Partially received units are treated in the same manner as a partially received contributed idea or a partially received connection link; and the same time of receipt is recorded for all of the contributed ideas and connection links that are submitted as part of a unit. Upon publication in the database, the same time of publication is listed for all of the contributed ideas and connection links that are submitted as part of a unit.

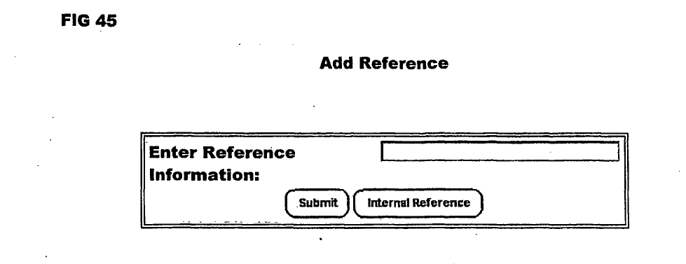

Referring again to the Publish an Idea screen display of FIG. 12, clicking the Add Reference button brings up the Add Reference screen display of FIG. 45, wherein an external reference may be identified by manually entering text in the Enter Reference Information space. Clicking the Submit button submits the identified external reference. If the user desires instead to enter an internal reference, the Internal Reference button is clicked.

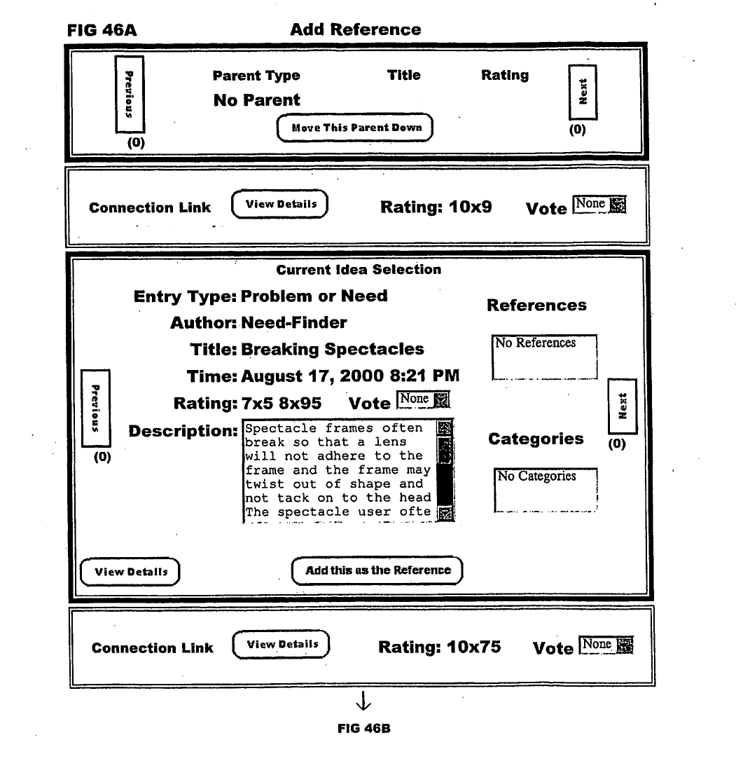

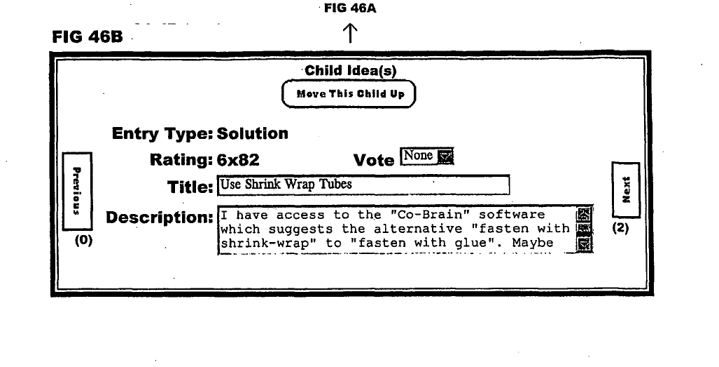

Clicking the Internal Reference button brings up the Add Reference screen display of FIG. 46, wherein a Current Idea Selection in the database, such as shown in the screen display of FIG. 19, may be accessed and added as a reference by selecting the desired contributed idea in the same manner as described above in describing the browse mode by clicking the “Add this as the reference” button.

Upon clicking the Add Categories button in the Publish an Idea screen display of FIG. 12, the user is enabled to select and add a category or categories from a list or lists of classes and subclasses of the United States Patent and Trademark Office and/or the Standard Industrial Classification (SIC) system to the respective idea file. If an appropriate class and/or subclass does not exist the user has the option of creating a new class and/or subclass. Other lists of classes may be used as a means for categorizing ideas and appropriate selection means are displayed to the user. Upon submission of the selected category or categories, selected category is associated with contributed idea described in the screen display from in which the Add Categories button is clicked.

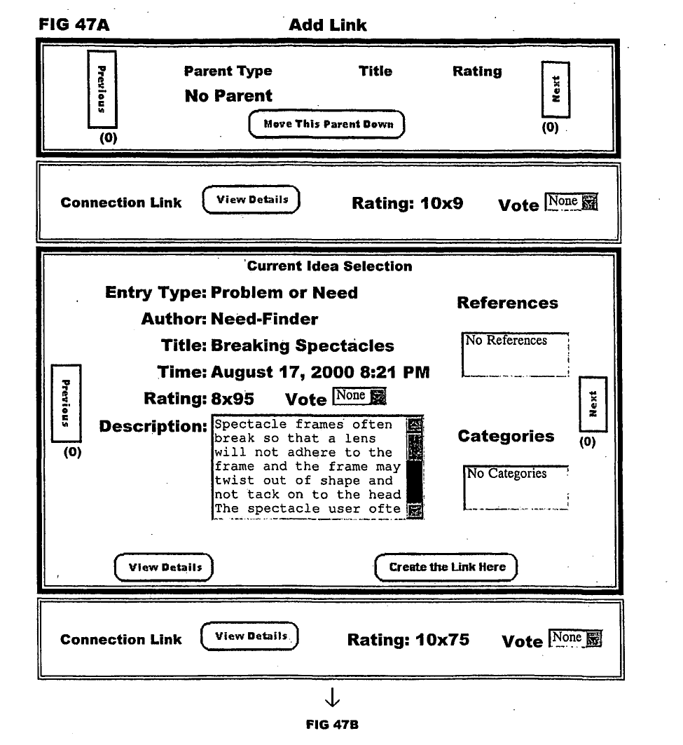

Clicking the Add Link button in the Publish an Idea screen display of FIG. 12 brings up the Add Link screen display of FIG. 47, wherein the Create the Link Here button is clicked to create the links shown in the Add Link screen display, after selecting the desired contributed idea in the same manner as described in describing the browse mode.

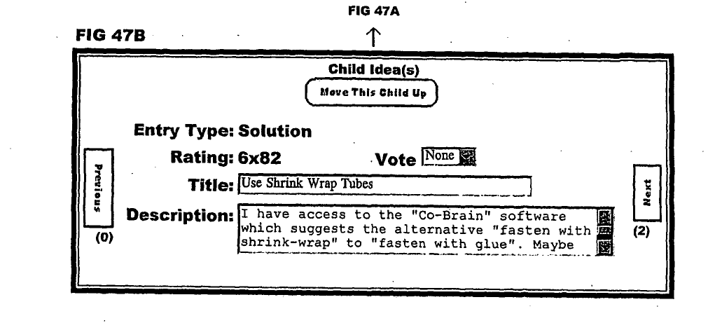

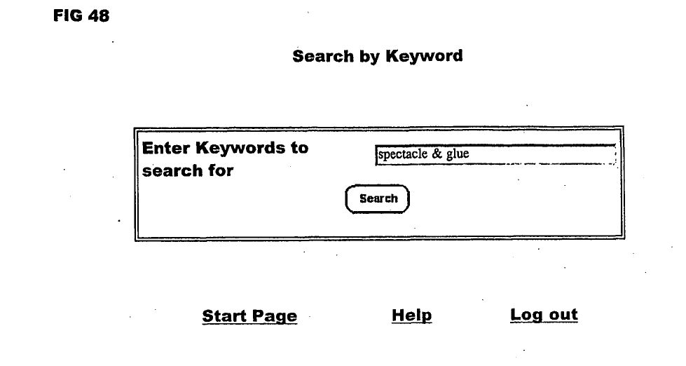

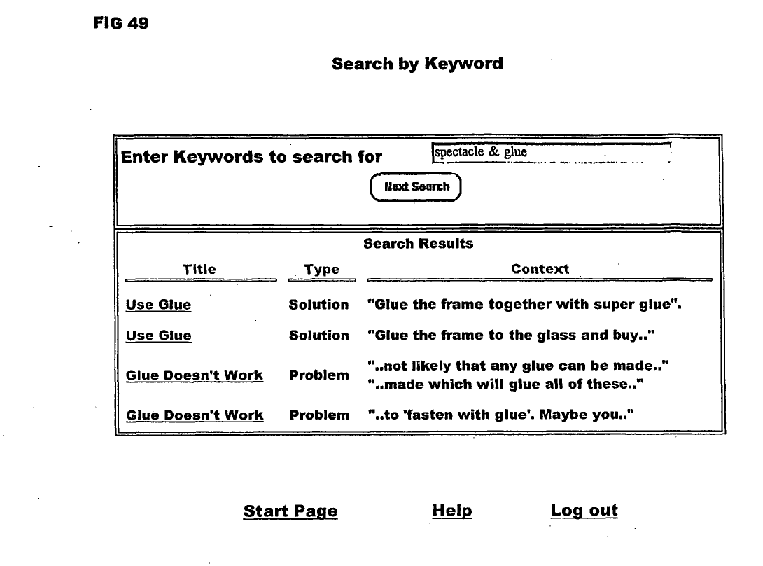

Referring to the Search for Contributions screen display of FIG. 13, clicking the Search for Keywords link brings up the screen display of FIG. 48. Clicking the search button in the screen display of FIG. 48 brings up the search results as shown in the screen display of FIG. 49.

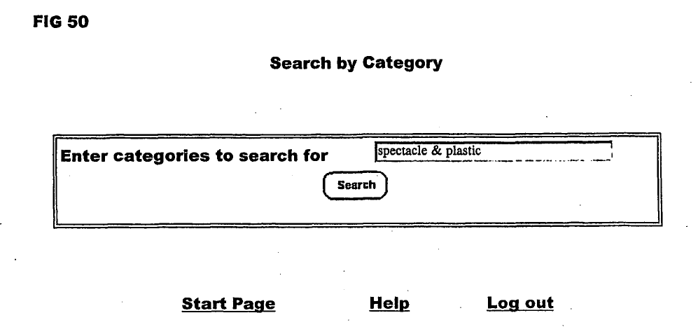

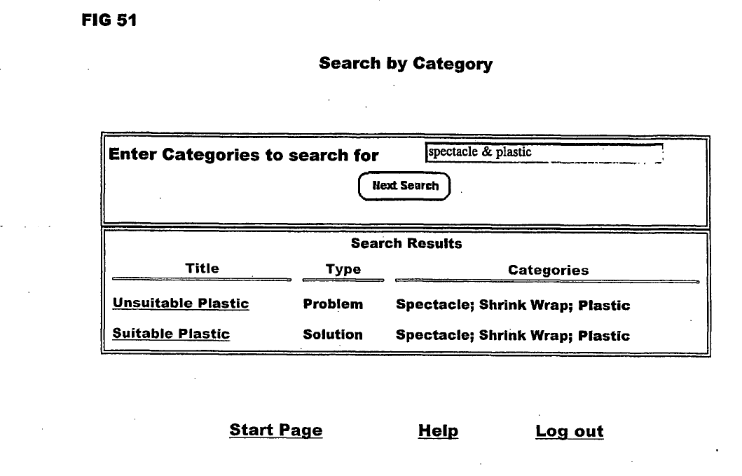

Clicking the Search by Categories link in the Search for Contributions screen display of FIG. 13 brings up the screen display of FIG. 50. Clicking the search button in the screen display of FIG. 50 brings up the search results as shown in the screen display of FIG. 51.

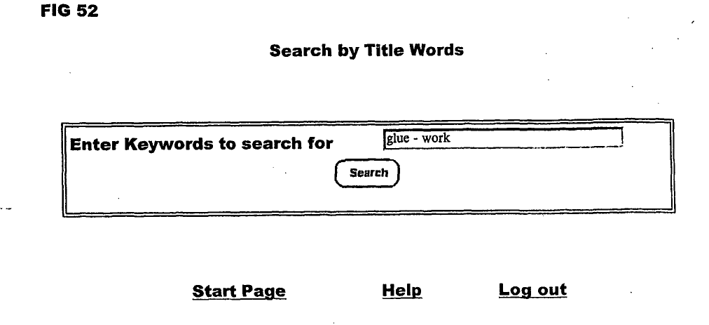

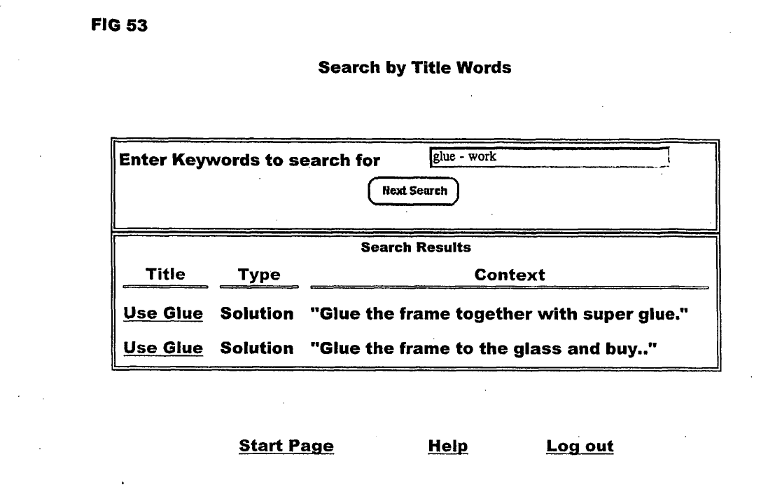

Clicking the Search by Title Words link in the Search for Contributions screen display of FIG. 13 brings up the screen display of FIG. 52. Clicking the search button in the screen display of FIG. 52 brings up the search results as shown in the screen display of FIG. 53.

Clicking the Advanced Search link in the Search for Contributions screen display of FIG. 13 enables a member user of the database to search the database for contributed ideas and/or connection links based on one or more sets of fields of their selection within the contributed files and/or connection links. The advanced search utilizes Boolean operators to logically combine together selections defined by key word entries within the same and different search fields. Wild cards are allowed for the key word entries in all fields.

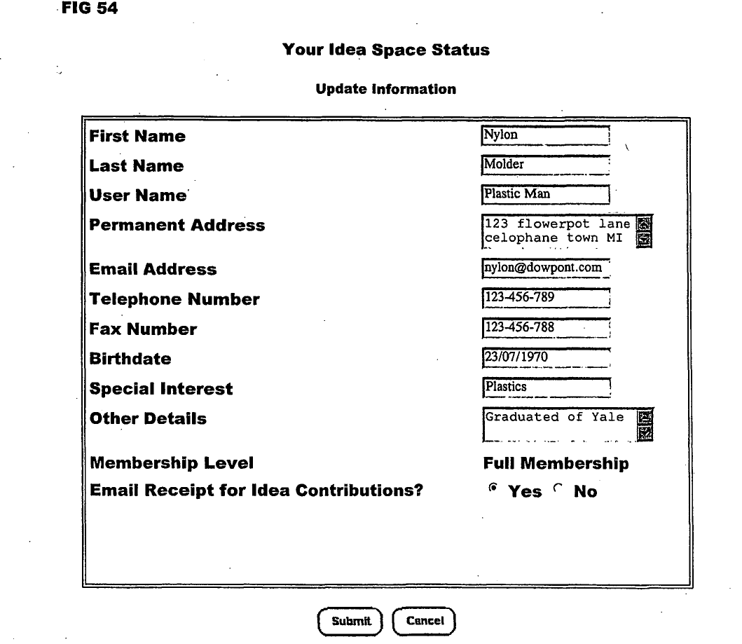

Clicking the Update Profile button in the Your Idea Space Status screen display of FIG. 18 brings up the screen display of FIG. 54. Note that the birth date of the user has been corrected in the screen display of FIG. 54.

In another preferred embodiment, the related ideas that are processed to provide an integrated idea in the database include contributed ideas of “problems with theories” and “solutions to problems with theories”. Preferably an integrated idea in accordance with this preferred embodiment is organized in the database by providing access links between contributed ideas of “problems with theories” and “solutions to problems with theories” and vise versa but generally not between contributed ideas of “problems with theories” and contributed ideas of “problems with theories” or between contributed ideas of “solutions to problems with theories” and contributed ideas of “solutions to problems with theories”. This preferred embodiment may have integrated ideas which are integrations of ideas of the other databases shown herein so that access links are preferably and generally created between contributed ideas of “solutions to problems with theories” and “problems with solutions and their enablement” and further between “problems with theories” and “solutions to problems and needs”. Alternatively such preferred embodiment may not be so integrated.

In the various embodiments of this invention the step of facilitating contribution of ideas to a computer database of ideas can be carried out automatically by the computer system. One example of such step being carried out automatically by a computer system would be as follows. In the exemplary embodiment described with reference to FIG. 2, where Idea 4 is contributed as a child of Idea 2 this step is accomplished by a human contributor; and where Idea 4 is contributed as a child of Idea 3, this latter contribution is accomplished automatically by a computer that is used to manage and provide the idea database in response to the computer recognizing the similarity of the words of Idea 2 and Idea 3. Such technology is known, and for example, is provided at http://www.cobrain.com. If an idea automatically contributed by a computer is inappropriate the idea will get a very low rating by the database users.

Another example of the step of facilitating contribution of ideas to a computer database of ideas being carried out automatically by a computer is as follows. Idea 10, which is based upon transparency, is contributed automatically by a computer owned and programmed by a member of the public in response to the computer recognizing the problem related to the word “color” in Idea 9. Such technology is also known, and for example, is provided at http://www.cobrain.com.

Another example of computer processing of ideas to provide an integrated idea is provided at website www.techoptimizer.com/products/Demo_Tech35/TO35_Demo.cfm, the disclosure of which is incorporated herein by reference thereto.

In some embodiments, the idea database 22 is maintained as a business by the idea manager 20, but is contributor and customer driven, in that some of the contributors 27 and some of the customers 28 suggest to the idea manager 20 when an idea is inappropriately located within the database 22 in relation to the search system. An idea file can be accessed by the search system by using a contributor identification code, a contributor-provided title; subject, keywords, time of entry into the database, time of publication (provision of access) on the database, time of first access of the idea entry, and/or the number of accesses to an idea entry. The time recordings are within an accuracy of one-one-hundredth or one-one-thousandth of a second. The search system is able to show a continuous listing of idea entries (files) in accordance with the time records.

In some embodiments, the time of entry into the database and the time of access from the database would be the same.

In some embodiments, the idea entries are never changed as a general rule, but may be repositioned in accordance with the search system.

In some preferred embodiments, the idea manager 20 systematically effects transfer of property rights to inventions 24 derived at least in part from the accumulated ideas to transferee customers, other than the contributors of the ideas from which the invention 24 was at least in part derived; and the computer system 21 is programmed to facilitate such transfers by on-line communications between the computer system 21 and the contributor computers 27 and/or the customer computers 28. Some such transfers that are pursuant to an obligation by the contributor to transfer such rights are to a transferee customer that was not identified upon establishment of said obligation.

In some preferred embodiments, the idea manager 20 systematically effects transfer of property rights 44 to inventions 24 derived at least in part from the accumulated ideas to itself 20 as the proprietor of the database 22 or to a party in concert with itself 20; and the computer system 21 is programmed to facilitate such transfers by on-line communications between the computer system 21 and the contributor computers 27 and/or the customer computers 28..

The transferred property rights 48 include rights to contributed ideas per se and/or at least some right under the patent rights to at least some of the inventions 24 derived at least in part from the ideas accumulated in the database 22, including both inventions derived from integrated contributed ideas and inventions innate to a single idea contributed by a single contributor.

Incident to facilitating transfer of such property rights 48, or independent of such transfer, the idea manager 20 (a) sells at least some right under the patent rights to at least some of the inventions 24; (b) auctions at least some right under the patent rights to at least some of the inventions 24; (c) brokers and/or markets at least some rights under the contingent contractual rights to at least some of the inventions 24; (d) acquires at least some right under the patent rights to at least some of the inventions 24; and/or (e) facilitates public sale of the acquired rights to at least some of the inventions 24. In the preferred embodiment, such sale, auction, brokering, marketing, acquisition and facilitation of public sale are performed systematically. In alternative embodiments one or more of such sale, auction, brokering, marketing, acquisition and facilitation of public sale are not performed systematically.

In the preferred embodiment, the idea manager 20 also systematically facilitates preparation and/or filing of patent applications for at least some of the unpatented inventions, as indicated at 50. Preferably, for some inventions, the step 48 of facilitating transfer of at least some right under the patent rights is carried out systematically before the step 50 of facilitating preparation and/or filing of a patent application. The computer system 21 is used to prepare and/or file a patent application for unpatented inventions innate to ideas in the database. 22. Computer software for preparing patent applications from a database including an idea of an invention includes “Patent Pro” brand software available from Kernel Creations, Ltd. and “Patent Wizard” brand software available from Patent Wizard, LLC of Fargo, N.D. Computer software for filing patent applications in various national patent offices has been provided by the various national patent offices.

In some embodiments, a customer is enabled upon payment of a fee to file a first right of refusal to the property rights to a prospectively patentable invention. Such a filing can be accessed with the idea entry. Such rights may include contingent rights provided by the idea manager 20 and/or transferred property rights.

In some preferred embodiments the computer system 21 is programmed to publish the conditions for sale or license of property rights to at least some of the prospectively patentable inventions 24 in the database 22 and/or a history of sale or license of property rights to at least some of such inventions 24 by entering such conditions and history in the database 22 for public or member viewing. Examples of such conditions include: for sale, not for sale, will take bids, will sell to highest bidder before a specified date, will sell for a specified amount or to the highest bidder by a specified date. Examples of such a history include: sold to FSHP Company on a given date for a stated amount and licensed to General Plastics on a given date for a stated royalty.

Preferably all of the various functions described herein are performed systematically. In alternative embodiments some of the various functions described herein are not performed systematically.

The present invention further provides computer readable storage media for use with computer systems, wherein the computer readable storage media include computer executable instructions for causing computer systems to perform and/or enable performance of the various functions described herein.

In still other embodiments the various embodiments described herein are combined with one another to the extent that they are not incompatible with each other.

The benefits specifically stated herein do not necessarily apply to every conceivable embodiment of the present invention. Further, such stated benefits of the present invention are only examples and should not be construed as the only advantages of the present invention.

While the above description contains many specificities, these specificities are not to be construed as limitations on the scope of the present invention, but rather as examples of the preferred embodiments described herein. Other variations are possible and the scope of the present invention are to be determined not by the embodiments described herein but rather by the claims and their legal equivalents. The claims require no implicit limitations. Each claim is to be construed explicitly as stated, or by its legal equivalent.

We claim:

1. A method of managing rights related to ideas for prospectively patentable inventions, comprising the steps of:
(a) receiving ideas for prospectively patentable inventions by on-line communications from contributors of said ideas, wherein said contributed ideas include problems or needs to be solved by inventions;
(b) accumulating said received ideas in a computer database;
(c) utilizing a computer system to effect transfers of property rights to inventions derived at least in part from said accumulated ideas that include said problems or needs respectively contributed by said contributors, wherein said transfers are to transferees other than said contributors whom respectively contributed said problems or needs;
(d) selling at least some right under the patent rights to at least some of said derived inventions; and
(e) providing economic gain of stock, bonds, cash or rights to a portion of anticipated income derived from said property rights to said contributors of said problems or needs.

2. A method according to claim 1, wherein step (b) comprises the step of:
(e) systematically entering into said database ideas contributed for entry into said database without requiring any contributor of said ideas to have subject matter expertise as a prerequisite for entry of said contributions.

3. A method according to claim 1, further comprising the step of:
(e) requiring persons to enter into a membership as a prerequisite for viewing a portion of said database containing at least some of said accumulated ideas.

4. A method according to claim 1, further comprising the step of:
(e) requiring contributors of ideas for prospective entry into said database to enter into a membership as a prerequisite for contributing ideas for entry into said database.

5. A method according to claim 1, further comprising the step of:
(e) auctioning at least some right under the patent rights to at least some inventions derived at least in part from said accumulated ideas.

6. A method according to claim 1, further comprising the step of:
(e) recording a time of receipt of each idea contributed for entry into said database.

7. A method according to claim 1, further comprising the step of:
(e) recording a time of publication in said database of each accumulated idea.

8. A method according to claim 1, further comprising the step of:
(e) enabling ideas contributed to said database to be integrated within said database to thereby facilitate derivation of inventions from said integrated ideas.

9. A method according to claim 8, wherein step (e) comprises the step of:
(f) providing access links between problem or need ideas and solution ideas received from contributors of said solution ideas.

10. A method according to claim 1, wherein said stock includes shares of stock in a proprietor of said database or a party in concert with the database proprietor.

11. A method according to claim 1, wherein step (d) is in exchange for acquiring or facilitating transfer of at least some of said property rights.

12. A method according to claim 1, wherein step (c) comprises effecting said transfers of property rights from said contributors of problems or needs whom contribute only said problems or needs.

13. A method according to claim 12, wherein step (e) comprises providing said economic gain to said contributors whom contribute only said problems or needs.

14. A method according to claim 1, wherein step (e) comprises providing rights to a portion of anticipated income derived from said property rights to said contributors whom contribute only said problems or needs.

15. A method according to claim 1, wherein step (e) comprises providing rights to a portion of anticipated income derived from said property rights to said contributors of said problems or needs.

16. A method according to claim 1, wherein at least some of said transfers are to a proprietor of said database or to a party in concert with said proprietor.

17. A method according to claim 1, wherein step (c) comprises the step of:
(e) utilizing a computer system to establish obligations by said contributors of problems or needs to transfer said property rights.

18. A method according to claim 1, wherein step (c) comprises the step of:
(e) establishing obligations by said contributors of problems or needs to transfer said property rights by utilizing a computer system that is programmed to facilitate said transfers by on-line communications with contributor computers.

19. A method according to claim 1, further comprising the step of:
(e) enabling ideas contributed to said database to be integrated by said contributors within said database to thereby facilitate derivation of inventions from said integrated ideas.

20. A method of managing rights related to ideas for prospectively patentable inventions, comprising the steps of:
(a) receiving ideas for prospectively patentable inventions by on-line communications from contributors of said ideas, wherein said contributed ideas include problems or needs to be solved by inventions;
(b) accumulating said received ideas in a computer database;
(c) utilizing a computer system to effect transfers of property rights to inventions derived at least in part from said accumulated ideas that include said problems or needs respectively contributed by said contributors, wherein said transfers are to transferees other than said contributors whom respectively contributed said problems or needs;
(d) recording a time of publication in said database of each accumulated idea; and
(e) providing economic gain of stock, bonds, cash or rights to a portion of anticipated income derived from said property rights to said contributors of said problems or needs.

21. A method according to claim 20, wherein step (e) comprises providing rights to a portion of anticipated income derived from said property rights to said contributors of said problems or needs.

22. A method of managing rights related to ideas for prospectively patentable inventions, comprising the steps of:
(a) receiving ideas for prospectively patentable inventions by on-line communications from contributors of said ideas, wherein said contributed ideas include problems or needs to be solved by inventions;
(b) accumulating said received ideas in a computer database;
(c) utilizing a computer system to establish obligations by said contributors of problems or needs to transfer property rights to inventions derived at least in part from said accumulated ideas that include said problems or needs contributed by said contributors, wherein said transfers are to transferees other than said contributors whom respectively contribute said problems or needs, and wherein said obligations are established as a prerequisite to contributing problems or needs; and
(d) providing economic gain of stock, bonds, cash or rights to a portion of anticipated income derived from said property rights to said contributors of said problems or needs.

23. A method according to claim 22, wherein step (c) includes utilizing the computer system to establish said obligations on at least the part of said contributors of problems or needs whom contribute only said problems or needs.

24. A method according to claim 23, wherein step (d) comprises providing said economic gain to said contributors whom contribute only said problems or needs.

25. A method according to claim 23, wherein step (d) comprises providing rights to a portion of anticipated income derived from said property rights to said contributors whom contribute only said problems or needs.

26. A method according to claim 22, wherein step (d) comprises providing rights to a portion of anticipated income derived from said property rights to said contributors whom contribute only said problems or needs.

27. A method according to claim 22, wherein step (d) comprises providing rights to a portion of anticipated income derived from said property rights to said contributors of said problems or needs.

28. A method according to claim 22, wherein the computer system is programmed to establish said obligations by on-line communications with contributor computers.

29. A method according to claim 22, wherein step (b) comprises the step of:
(e) systematically entering into said database ideas contributed for entry into said database without requiring any contributor of said ideas to have subject matter expertise as a prerequisite for entry of said contributions.

30. A method according to claim 22, further comprising the step of:
(e) requiring persons to enter into a membership as a prerequisite for viewing a portion of said database containing at least some of said accumulated ideas.

31. A method according to claim 22, further comprising the step of:
(e) requiring contributors of ideas for prospective entry into said database to enter into a membership as a prerequisite for contributing ideas for entry into said database.

32. A method according to claim 22, further comprising the step of:
(e) auctioning at least some right under the patent rights to at least some inventions derived at least in part from said accumulated ideas.

33. A method according to claim 22, further comprising the step of:
(e) recording a time of receipt of each idea contributed for entry into said database.

34. A method according to claim 22, further comprising the step of:
(e) recording a time of publication in said database of each accumulated idea.

35. A method according to claim 22, further comprising the step of:
(e) enabling ideas contributed to said database to be integrated within said database to thereby facilitate derivation of inventions from said integrated ideas.

36. A method according to claim 35, wherein step (e) comprises the step of:
(f) providing access links between problem or need ideas and solution ideas received from contributors of said solution ideas.

37. A method according to claim 22, further comprising the step of:
(e) enabling ideas contributed to said database to be integrated by said contributors within said database to thereby facilitate derivation of inventions from said integrated ideas.

38. A method according to claim 22, wherein said stock includes shares of stock in a proprietor of said database or a party in concert with the database proprietor.

39. A method according to claim 22, wherein step (d) is in exchange for acquiring or facilitating transfer of at least some of said property rights.

40. A method of managing rights related to an idea for a prospectively patentable invention, comprising the steps of:
(a) receiving an idea for a prospectively patentable invention by an on-line communication from a contributor of said idea, wherein said contributed idea is a problem and/or a need to be solved by one or more inventions;
(b) accumulating said received idea in a computer database;
(c) utilizing a computer system to effect a transfer of property rights to inventions derived at least in part from said accumulated ideas that include said problem or need contributed by said contributor, wherein said transfer is to a transferee other than said contributor;
(d) selling at least some right under the patent rights to at least some of said derived inventions; and
(e) providing economic gain of stock, bonds, cash or rights to a portion of anticipated income derived from said property rights to said contributor of said problem and/or need.

41. A method according to claim 40, wherein step (c) includes effecting 'said transfer of property rights from a said contributor of problems or needs whom contributes only said problems or needs.

42. A method according to claim 41, wherein step (e) comprises providing said economic gain to a said contributor whom contributes only said problems or needs.

43. A method according to claim 41, wherein step (e) comprises providing rights to a portion of anticipated income derived from said property rights to a said contributor whom contributes only said problems or needs.

44. A method according to claim 40, wherein step (e) comprises providing rights to a portion of anticipated income derived from said property rights to a said contributor whom contributes only said problems or needs.

45. A method according to claim 40, wherein step (e) comprises providing rights to a portion of anticipated income derived from said property rights to said contributor of said problems or needs.

46. A method according to claim 40, wherein step (c) comprises the step of:
(e) utilizing a computer system to establish an obligation by said contributor of said problem or need to transfer said property rights.

47. A method according to claim 40, wherein step (c) comprises the step of:
(e) establishing an obligation by said contributor of said problem and/or need to transfer said property rights by utilizing a computer system that is programmed to facilitate said transfer by on-line communication with a contributor computer.

48. A computer readable storage medium(media), comprising computer executable instructions for causing a computer(s) to manage rights related to ideas for prospectively patentable inventions, wherein the instructions cause the computer(s) to perform the steps of:
(a) receiving ideas for prospectively patentable inventions by on-line communications from contributors of said ideas, wherein said contributed ideas include problems or needs to be solved by inventions;
(b) accumulating said received ideas in a computer database;
(c) effecting transfers of property rights to inventions derived at least in part from said accumulated ideas that include said problems or needs respectively contributed by said contributors, wherein said transfers are to transferees other than said contributors whom respectively contributed said problems or needs;
(d) selling at least some right under the patent rights to at least some of said derived inventions; and
(e) providing economic gain of stock, bonds, cash or rights to a portion of anticipated income derived from said property rights to said contributors of said problems or needs.

49. A computer readable storage medium(media) according to claim 48, wherein step (c) includes effecting said transfers of property rights from said contributors of problems or needs whom contribute only said problems or needs.

50. A computer readable storage medium(media) according to claim 49, wherein step (e) comprises providing said economic gain to said contributors whom contribute only said problems or needs.

51. A computer readable storage medium(media) according to claim 48, wherein step (e) comprises providing rights to a portion of anticipated income derived from said property rights to said contributors whom contribute only said problems or needs.

52. A computer readable storage medium(media) according to claim 48, wherein step (e) comprises providing rights to a portion of anticipated income derived from said property rights to said contributors of said problems or needs.

53. A computer readable storage medium(media), comprising computer executable instructions for causing a computer(s) to manage rights related to ideas for prospectively patentable inventions, wherein the instructions cause the computer(s) to perform the steps of:
(a) receiving ideas for prospectively patentable inventions by on-line communications from contributors of said ideas, wherein said contributed ideas include problems or needs to be solved by inventions;
(b) accumulating said received ideas in a computer database;
(c) establishing obligations by said contributors of problems or needs to transfer property rights to inventions derived at least in part from said accumulated ideas that include said problems or needs contributed by said contributors, wherein said transfers are to transferees other than said contributors whom respectively contribute said problems or needs, and wherein said obligations are established as a prerequisite to contributing problems or needs; and
(d) providing economic gain of stock, bonds, cash or rights to a portion of anticipated income derived from said property rights to said contributors of said problems or needs.

54. A computer readable storage medium(media) according to claim 53, wherein step (c) includes utilizing the computer system to establish said obligations on at least the part of said contributors of problems or needs whom contribute only said problems or needs.

55. A computer readable storage medium(media) according to claim 54, wherein step (d) comprises providing said economic gain or said rights to a portion of anticipated income to said contributors whom contribute only said problems or needs.

56. A computer readable storage medium(media) according to claim 53, wherein step (d) comprises providing rights to a portion of anticipated income derived from said property rights to said contributors whom contribute only said problems or needs.

57. A computer readable storage medium(media) according to claim 53, wherein step (d) comprises providing rights to a portion of anticipated income derived from said property rights to said contributors of said problems or needs.
